(19) United States
(12) Patent Application Publication
(10) Pub. No.: US 2014/0307072 A1
(43) Pub. Date: Oct. 16, 2014

(54) IMAGE PROCESSING DEVICE, IMAGE PROCESSING METHOD, AND INFORMATION STORAGE DEVICE

(71) Applicant: OLYMPUS CORPORATION, Tokyo (JP)

(72) Inventor: Jumpei TAKAHASHI, Tokyo (JP)

(73) Assignee: OLYMPUS CORPORATION, Tokyo (JP)

(21) Appl. No.: 14/215,184

(22) Filed: Mar. 17, 2014

(30) Foreign Application Priority Data
Apr. 16, 2013 (JP) 2013-085675

(51) Int. Cl. H04N 5/232

(52) U.S. Cl. CPC H04N 5/23296
USPC 348/65

(57) ABSTRACT

An image processing device includes an image acquisition section that acquires an image in time series, the image having been captured by an imaging section, and including an object, a distance acquisition section that acquires distance information based on the distance from the imaging section to the object, and links the distance information to the image, an electronic zoom condition setting section that sets at least an electronic zoom magnification as an electronic zoom condition, and an electronic zoom processing section that performs an electronic zoom process on the image based on the electronic zoom condition, the electronic zoom condition setting section increasing the electronic zoom magnification as the distance indicated by the distance information decreases.

Japanese Patent Application No. 2013-085675 filed on Apr. 16, 2013, is hereby incorporated by reference in its entirety.

### BACKGROUND

The present invention relates to an image processing device, an image processing method, an information storage device, and the like.

A lesion can be found in an early stage during endoscopic diagnosis through zoom observation of a pit pattern (glandular structure) or a blood vessel pattern on the surface of tissue. Zoom observation is performed in a state in which the scope is positioned close to tissue. However, the magnification achieved by the optical system is limited since the object becomes out of focus when the scope is brought too close to the object. Therefore, electronic zoom has been normally utilized to increase the magnification. The visibility of a pit pattern and a blood vessel pattern can be improved by utilizing electronic zoom.

However, since the existing endoscopic scope is designed so that the doctor manually enables/disables electronic zoom, or changes the magnification, the burden imposed on the doctor may increase.

The above problem is not limited to an endoscope system (endoscope apparatus or device). For example, when closely capturing the object using a normal digital camera by utilizing a single-focus macro lens or the like (macro shooting), the minimum distance to the object is limited due to the lens characteristics even when it is desired to more closely capture the object. In this case, electronic zoom may be utilized when it is desired to magnify the object image at the expense of resolution.

Specifically, it may be desired to control electronic zoom corresponding to the distance to the object. JP-A-2011-166496 discloses a technique that automatically controls the electronic zoom magnification based on the distance between the object and the image sensor.

The technique disclosed in JP-A-2011-166496 performs a magnification process (i.e., a process that sets a value larger than 1 as the electronic zoom magnification) when the distance to the object has increased, and performs a demagnification process (i.e., a process that sets a value smaller than 1 as the electronic zoom magnification) when the distance to the object has decreased. The technique disclosed in JP-A-2011-166496 aims to prevent a change in the size of the object within the image even when a change in the distance to the object has occurred.

Since the depth-of-field range is fixed, magnification of the object by bringing the imaging device close to the object is limited. Therefore, when the distance to the object has decreased, the magnification is increased by performing the magnification process utilizing electronic zoom.

### SUMMARY

According to one aspect of the invention, there is provided an image processing device comprising:

an image acquisition section that acquires an image in time series, the image having been captured by an imaging section, and including an object;

a distance acquisition section that acquires distance information based on a distance from the imaging section to the object;

an electronic zoom condition setting section that sets at least an electronic zoom magnification as an electronic zoom condition, the electronic zoom condition being a condition for an electronic zoom process; and

an electronic zoom processing section that performs the electronic zoom process on the image based on the electronic zoom condition,

the electronic zoom condition setting section increasing the electronic zoom magnification as the distance indicated by the distance information decreases with respect to a given depth of field of the imaging section.

According to another aspect of the invention, there is provided an image processing method comprising:

acquiring an image in time series, the image having been captured by an imaging section, and including an object;

acquiring distance information based on a distance from the imaging section to the object;

increasing an electronic zoom magnification as the distance indicated by the distance information decreases with respect to a given depth of field of the imaging section; and

performing an electronic zoom process on the image using the electronic zoom magnification.

According to another aspect of the invention, there is provided an information storage device with an executable program stored thereon, wherein the program instructs a computer to perform steps of:

acquiring an image in time series, the image having been captured by an imaging section, and including an object;

acquiring distance information based on a distance from the imaging section to the object;

increasing an electronic zoom magnification as the distance indicated by the distance information decreases with respect to a given depth of field of the imaging section; and

performing an electronic zoom process on the image using the electronic zoom magnification.

### BRIEF DESCRIPTION OF THE DRAWINGS

FIG. 1 illustrates a system configuration example of an endoscope system that includes an image processing device according to one embodiment of the invention.

FIG. 2 illustrates a configuration example of an image sensor.

FIG. 3 illustrates an example of the spectral sensitivity characteristics of a color filter.

FIG. 4 illustrates an example of a depth-of-field range at a near point and a far point.

FIG. 5 illustrates a configuration example of an image processing section.

FIG. 6 illustrates a configuration example of a distance acquisition section.

FIG. 7 illustrates a configuration example of an electronic zoom condition setting section.

FIGS. 8A to 8E are views illustrating a zoom center position setting method.

FIG. 9 illustrates a configuration example of a reliability determination section.

FIGS. 10A and 10B illustrate an example of the relationship between a distance and an electronic zoom magnification.

FIG. 11 is a flowchart illustrating a process according to one embodiment of the invention.

FIG. 12 is a flowchart illustrating an embodiment that utilizes software.

FIG. 13 illustrates another system configuration example of an endoscope system that includes an image processing device according to one embodiment of the invention.

FIG. 14 illustrates an example of the spectrum of each light source.

FIG. 15 illustrates another configuration example of an image processing section.

FIG. 16 illustrates another configuration example of a distance acquisition section.

FIG. 17 illustrates another configuration example of a reliability determination section.

FIG. 18 is another flowchart illustrating an embodiment that utilizes software.

FIG. 19 illustrates a system configuration example of an image processing device according to one embodiment of the invention.

### DESCRIPTION OF EXEMPLARY EMBODIMENTS

According to one embodiment of the invention, there is provided an image processing device comprising:

an image acquisition section that acquires an image in time series, the image having been captured by an imaging section, and including an object;

a distance acquisition section that acquires distance information based on a distance from the imaging section to the object;

an electronic zoom condition setting section that sets at least an electronic zoom magnification as an electronic zoom condition, the electronic zoom condition being a condition for an electronic zoom process; and

an electronic zoom processing section that performs the electronic zoom process on the image based on the electronic zoom condition,

the electronic zoom condition setting section increasing the electronic zoom magnification as the distance indicated by the distance information decreases with respect to a given depth of field of the imaging section.

According to another embodiment of the invention, there is provided an image processing method comprising:

acquiring an image in time series, the image having been captured by an imaging section, and including an object;

acquiring distance information based on a distance from the imaging section to the object;

increasing an electronic zoom magnification as the distance indicated by the distance information decreases with respect to a given depth of field of the imaging section; and

performing an electronic zoom process on the image using the electronic zoom magnification.

According to another embodiment of the invention, there is provided a computer-readable storage device with an executable program stored thereon, wherein the program instructs a computer to perform steps of:

acquiring an image in time series, the image having been captured by an imaging section, and including an object;

acquiring distance information based on a distance from the imaging section to the object;

increasing an electronic zoom magnification as the distance indicated by the distance information decreases with respect to a given depth of field of the imaging section; and

performing an electronic zoom process on the image using the electronic zoom magnification.

Exemplary embodiments of the invention are described below. Note that the following exemplary embodiments do not in any way limit the scope of the invention laid out in the claims. Note also that all of the elements described in connection with the following exemplary embodiments should not necessarily be taken as essential elements of the invention.

### 1. Method

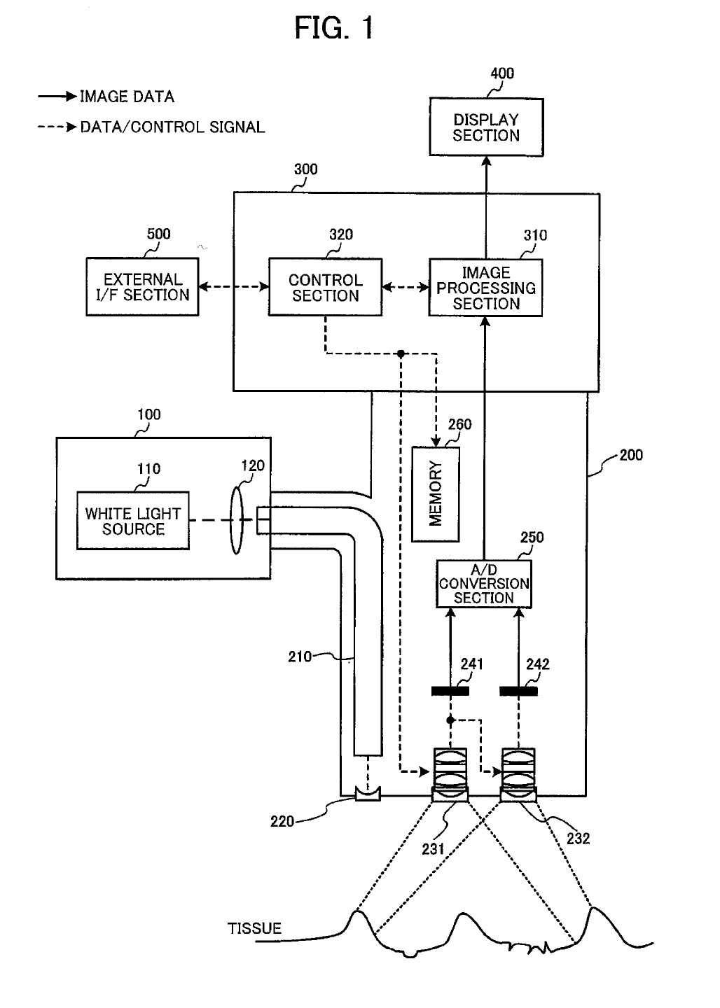

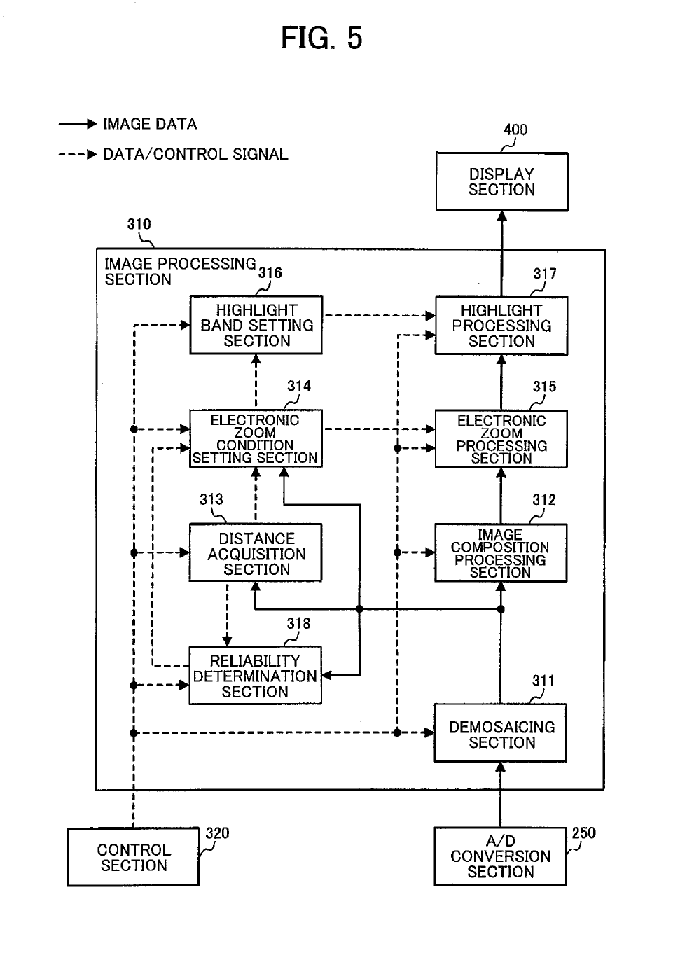

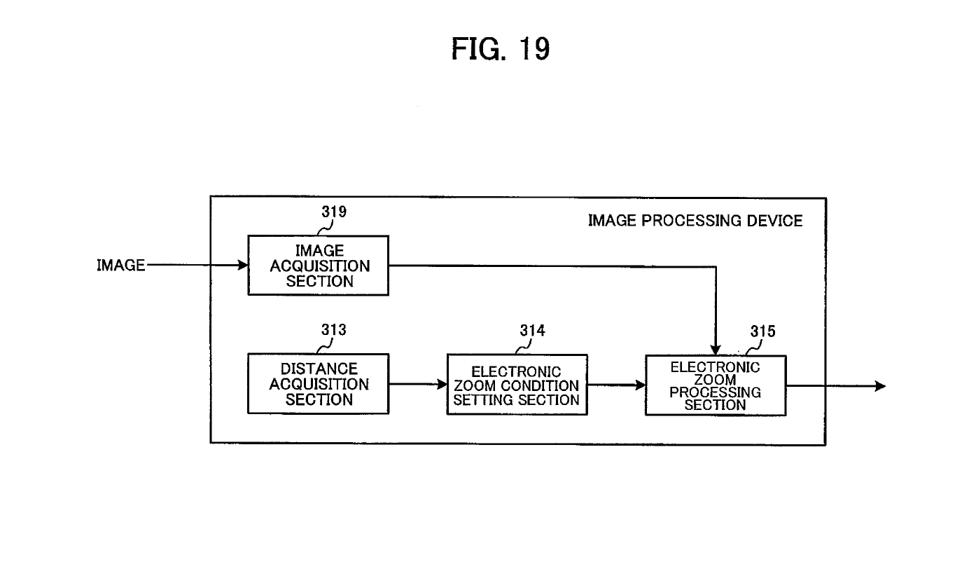

A method employed in connection with several exemplary embodiments of the invention is described below. An image processing device according to several embodiments of the invention includes an image acquisition section 319 (corresponding to a demosaicing section 311 and an image composition processing section 312 illustrated in FIG. 5 (described later)) that acquires an image in time series, the image having been captured by an imaging section (e.g., imaging section 200 illustrated in FIG. 1 (described later)), and including an object, a distance acquisition section 313 that acquires distance information based on the distance from the imaging section to the object, and links the distance information to the image, an electronic zoom condition setting section 314 that sets at least an electronic zoom magnification as an electronic zoom condition, and an electronic zoom processing section 315 that performs an electronic zoom process on the image based on the electronic zoom condition set by the electronic zoom condition setting section 314, the electronic zoom condition setting section 314 increasing the electronic zoom magnification as the distance indicated by the distance information decreases (see FIG. 19).

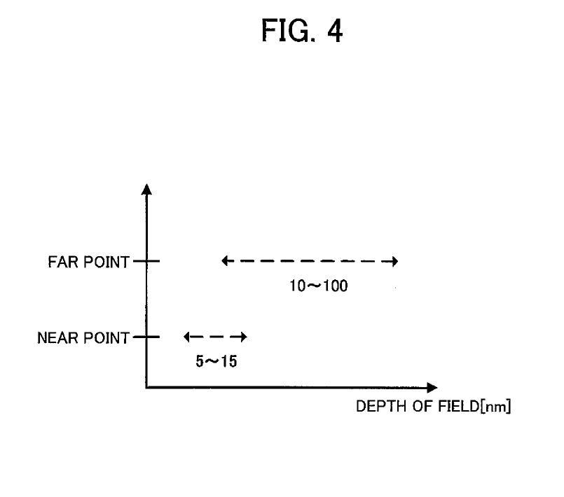

The above configuration makes it possible to increase the electronic zoom magnification as the distance from the imaging section to the object decreases, and perform the electronic zoom process using the electronic zoom magnification that has been set. As illustrated in FIG. 4, even if the depth-of-field range is set at a position close to imaging section (see the near point), a certain distance (5 mm in the example illustrated in FIG. 4) is present between the imaging section and the endpoint of the depth-of-field range on the side of the imaging section. When the imaging section is brought closer to the object in order to magnify the object, and the distance between the imaging section and the object becomes shorter than the above distance, the object lies outside the depth-of-field range, and becomes out of focus (i.e., the magnification is limited).

According to the above method, since the magnification can be increased by electronic zoom, the object can be magnified. Since the electronic zoom magnification is automatically controlled based on the distance from the imaging section to the object, the user need not perform a complex operation.

The method according to several embodiments of the invention can be applied to various image processing devices. The following description is given taking an endoscope system as an example. An endoscope system is designed so that zoom observation can be implemented by bringing the end of the scope close to tissue. The tissue can be magnified during zoom observation by switching the in-focus object plane position to the near point. Note that a configuration that switches the in-focus object plane position to the near point or the far point is not an essential requirement of the invention.

However, since the objective lens (objective lenses 231 and 232 in FIG. 1 (described later)) has a given depth of field, the tissue becomes out of focus when the scope is brought close to the tissue to a large extent. Specifically, the magnification achieved by the optical system is limited, and it is difficult to obtain a magnification sufficient to qualitatively diagnose a lesion. If the magnification is further increased by setting the in-focus object plane position to a nearer point, the depth of field narrows to a large extent, and it becomes difficult to bring the object into focus (i.e., convenience to the user deteriorates). Therefore, the magnification is increased by utilizing electronic zoom. However, since the doctor must manually enables/disables electronic zoom, a complex operation is required for the doctor.

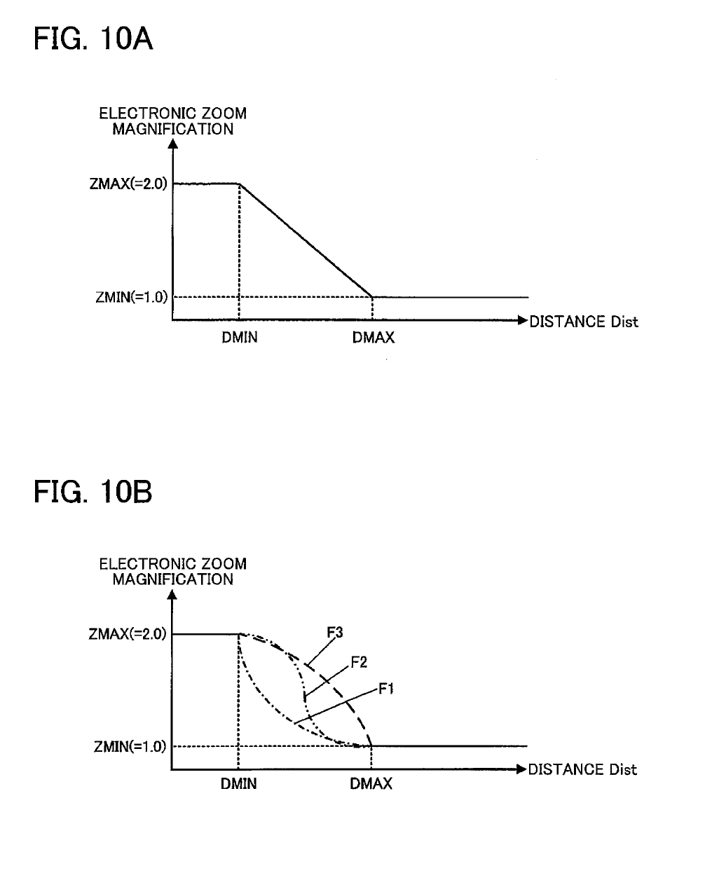

Several embodiments of the invention solve the above problem by automatically controlling electronic zoom, and improve the operability of the scope. Specifically, the electronic zoom magnification is automatically controlled based on the distance between the scope and the tissue that is detected by a stereo matching technique (described later). The electronic zoom magnification is controlled based on the distance (see FIG. 10) using a method described later. According to the above configuration, electronic zoom functions by merely bringing the scope close to the tissue, and a lesion can be qualitatively diagnosed. Since the electronic zoom magnification is gradually increased corresponding to the distance, it is possible to suppress discontinuity that occurs when electronic zoom is enabled/disabled.

When using the above method, however, the electronic zoom magnification may change due to an unintended motion for the doctor (e.g., the pulsation of the tissue, or shake), and an image that is difficult to observe may be displayed. Since the stereo matching technique is used to detect the distance, the detected distance may be unstable, and the electronic zoom magnification may change unnaturally when the structure of the tissue is flat, or the tissue lies outside the depth of field, and is out of focus. The above problem may also occur when a bright spot or a dark area is present in the image.

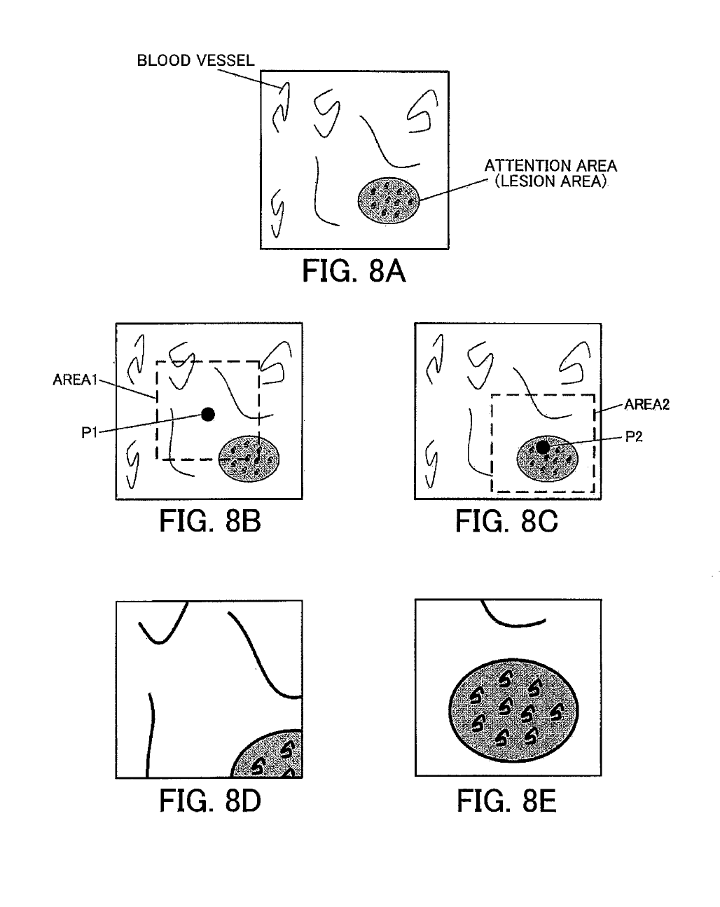

When using the electronic zoom process, the field of view of the display image is narrower than that of the original image. However, the endoscope system cannot necessarily capture the attention area for the doctor at the center of the display image due to the structure of the tissue. In FIG. 8A, the attention area (i.e., an area that is suspected to be a lesion) is present in the peripheral area of the image. The magnification achieved by the optical magnification is limited as described above. However, it is difficult to closely observe the blood vessel pattern that is important for diagnosis of the attention area without increasing the magnification. Therefore, the visibility of the blood vessel pattern is improved by utilizing electronic zoom. However, when the electronic zoom process is performed on the image illustrated in FIG. 8A, the area AREA1 illustrated in FIG. 8B is displayed after the electronic zoom process, and the entire attention area may not be displayed (see FIG. 8D).

In order to deal with the above problem, several aspects and embodiments of the invention propose a method that adaptively controls the electronic zoom magnification Z and the zoom center position (center coordinates (PX, PY) in a narrow sense) as the electronic zoom conditions corresponding to the diagnostic situation (scene). An outline of the method described below. The details of the process will be described in connection with a first embodiment and a second embodiment.

Specifically, the electronic zoom magnification is controlled as illustrated in FIG. 10A or 10B based on the distance Dist from the imaging section to the object. It is possible to increase the electronic zoom magnification as the distance decreases (i.e., when it is considered that the user desires to further magnify the object) by controlling the electronic zoom magnification as illustrated in FIG. 10A or 10B.

However, it is necessary to reduce the effects of an unintended change in distance (e.g., a change in distance due to shake) or a decrease in stereo matching accuracy, for example. According to several embodiments of the invention, the distance Dist_Now acquired at the processing target timing is not used directly as the distance Dist. The distance Dist is determined corresponding to the reliability determination result utilizing the distance Dist_Pre that is the distance Dist acquired at a previous timing, or the like.

Various reliability determination methods may be used. According to several embodiments of the invention, when a temporal change in distance (e.g., the difference between the distance Dist_Now and the distance Dist_Pre) is large, it is determined that the reliability of the distance information is low on the assumption that an unintended change in distance (e.g., a change in distance due to shake) has occurred. The temporal motion of the object within the image (e.g., the motion vector between the images acquired at different timings) is also determined, and it is determined that the reliability of the distance information is low when the motion of the object is large.

When acquiring the distance information by stereo matching, the reliability of the distance information is determined taking account of whether or not the stereo matching process has been appropriately performed. For example, when the contrast of the image is low (i.e., when the entire image is flat), the accuracy of the image matching process tends to deteriorate. In this case, it is determined that the reliability of the distance information is low since it is considered that the accuracy of the distance information acquired by the stereo matching process is also low.

The details of the relationship between the reliability determination result and the distance (Dist) calculation process based on the reliability determination result are described later. When the reliability of the distance information is low, the distance Dist_Now is not used to calculate the distance Dist, or the degree of contribution of the distance Dist_Now is decreased when calculating the distance Dist. When the reliability of the distance information is high, the distance Dist_Now is used to calculate the distance Dist. In particular, the degree of contribution of the distance Dist_Now when calculating the distance Dist is increased as compared with the case where the reliability of the distance information is low.

The zoom center position (PX, PY) used for the electronic zoom process is determined taking account of the area to which the user pays attention, for example. The zoom center position may be set to within the area to which the user pays much attention. A specific method is described later. In this case, the electronic zoom magnification and the zoom center position are set as the electronic zoom conditions, and the electronic zoom process is performed around the zoom center position set as the electronic zoom condition using the electronic zoom magnification set as the electronic zoom condition.

The details of the above method are described below in connection with the first embodiment and the second embodiment. Although the following description is given taking an endoscope system as an example (see FIG. 1 and the like), the method according to several embodiments of the invention may also be applied to an image processing device other than an endoscope system.

### 2. First Embodiment

The first embodiment is described below. A system configuration example according to the first embodiment will be described first, and the details of the process performed by each section will then be described. The flow of the process will then be described using a flowchart, followed by description of modifications.

### 2.1 System Configuration Example

An endoscope system that includes an image processing device according to the first embodiment is described below with reference to FIG. 1. As illustrated in FIG. 1, the endoscope system that includes the image processing device according to the first embodiment includes a light source section 100, an imaging section 200, a processor part 300 (corresponding to the image processing device), a display section 400, and an external I/F section 500.

The light source section 100 includes a white light source 110, and a condenser lens 120 that focuses white light emitted from the white light source 110 on a light guide fiber 210.

The imaging section 200 is formed to be elongated and flexible so that the imaging section 200 can be inserted into a body cavity, for example. Note that the imaging section 200 may be hereinafter referred to as “scope”. The imaging section 200 is configured to be removable. A plurality of types of imaging sections 200 are provided. Examples of the imaging section 200 include an upper gastrointestinal scope, a lower gastrointestinal scope, and the like.

The imaging section 200 includes the light guide fiber 210 that guides the white light emitted from the white light source 100 to the end of the imaging section 200, an illumination lens 220 that diffuses the white light guided by the light guide fiber 210, and applies the diffused white light to tissue, objective lenses 231 and 232 that focus light from the surface of the tissue, image sensors 241 and 242 that detect the focused light, an A/D conversion section 250 that converts analog signals photoelectrically converted by the image sensors 241 and 242 into digital signals, and a memory 260. The objective lenses 231 and 232 and the memory 260 are connected to a control section 320.

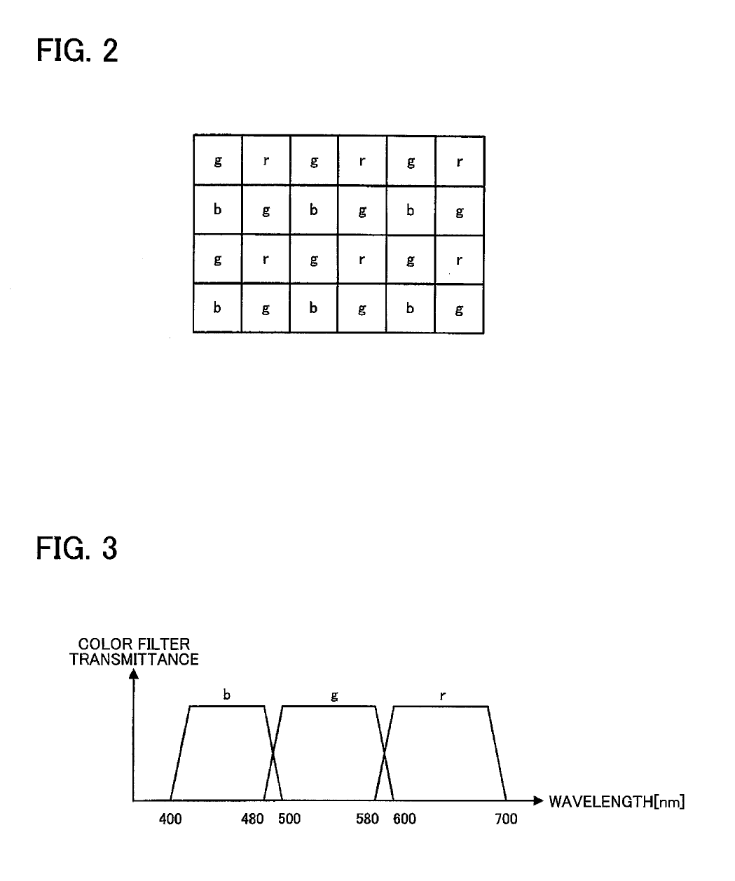

The image sensors 241 and 242 include a Bayer color filter array illustrated in FIG. 2. The color filter array includes r, g, and b color filters. The r, g, and b color filters have the spectral sensitivity characteristics illustrated in FIG. 3, for example. The image sensors 241 and 242 are disposed at an interval at which a given parallax image (hereinafter referred to as “stereo image”) can be captured. The distance between the image sensor 241 and the surface of the tissue can be acquired by a stereo matching process described later. Note that an image captured by the image sensor 241 is hereinafter referred to as “left image”, an image captured by the image sensor 242 is hereinafter referred to as “right image”, and the left image and the right image are hereinafter collectively referred to as “stereo image”.

The objective lenses 231 and 232 are configured so that the in-focus object plane position can be controlled by driving the lens position. The in-focus object plane position refers to a near point/far point. The doctor can arbitrarily switch the in-focus object plane position through the external I/F section 500 (described later). The control section 320 drives the lens position based on a signal output from the external I/F section 500. The far point is used when it is desired to observe the entire digestive organ (e.g., during screening), and the near point is used when it is desired to closely observe a lesion area (e.g., zoom observation). In the first embodiment, the objective lenses 231 and 232 have a given depth of field. For example, the objective lenses 231 and 232 have a depth of field of 5 to 15 mm when the in-focus object plane position is the near point, and have a depth of field of 10 to 100 mm when the in-focus object plane position is the far point (see FIG. 4).

An identification number of each scope is stored in the memory 260. The in-focus object plane position and the depth of field differ depending on the connected scope. The control section 320 can determine the type of the connected scope by referring to the identification number stored in the memory 260 to acquire information about the in-focus object plane position and the depth of field.

The processor section 300 includes an image processing section 310 and the control section 320. The image processing section 310 performs image processing (described later) on the stereo image output from the A/D conversion section 250 to generate a display image, and outputs the generated display image to the display section 400. The control section 320 controls the operation of the image processing section 310 based on a signal output from the external IN section 500 (described later).

The display section 400 is a display device that can display the display image output from the processor section 300 as a movie. The display section 400 is implemented by a CRT, a liquid crystal monitor, or the like.

The external I/F section 500 is an interface that allows the user to input information to the endoscope system, for example. The external I/F section 500 includes an in-focus object plane position (near point/far point) switch button, a highlight process ON/OFF button, a power ON/OFF button, a mode (e.g., imaging mode) switch button, and the like.

FIG. 5 illustrates a configuration example of the image processing section 310. The image processing section 310 includes a demosaicing section 311, an image composition processing section 312, a distance acquisition section 313, an electronic zoom condition setting section 314, an electronic zoom processing section 315, a highlight band setting section 316, a highlight processing section 317, and a reliability determination section 318.

The A/D conversion section 250 is connected to the demosaicing section 311. The demosaicing section 311 is connected to the image composition processing section 312, the distance acquisition section 313, the electronic zoom condition setting section 314, and the reliability determination section 318. The image composition processing section 312 is connected to the electronic zoom processing section 315. The distance acquisition section 313 is connected to the electronic zoom condition setting section 314 and the reliability determination section 318. The electronic zoom condition setting section 314 is connected to the electronic zoom processing section 315 and the highlight band setting section 316. The electronic zoom processing section 315 and the highlight band setting section 316 are connected to the highlight processing section 317. The highlight processing section 317 is connected to the display section 400. The reliability determination section 318 is connected to the electronic zoom condition setting section 314.

The control section 320 is connected to the demosaicing section 311, the image composition processing section 312, the distance acquisition section 313, the electronic zoom condition setting section 314, the electronic zoom processing section 315, the highlight band setting section 316, the highlight processing section 317, and the reliability determination section 318, and controls the demosaicing section 311, the image composition processing section 312, the distance acquisition section 313, the electronic zoom condition setting section 314, the electronic zoom processing section 315, the highlight band setting section 316, the highlight processing section 317, and the reliability determination section 318.

The demosaicing section 311 performs a demosaicing process on the stereo image output from the A/D conversion section 250. Since the image sensors 241 and 242 include the Bayer color filter array, each pixel has only an R, G, or B signal. Therefore, an RGB image is generated using a known bicubic interpolation process or the like. The demosaicing section 311 outputs the stereo image subjected to the demosaicing process to the image composition processing section 312, the distance acquisition section 313, and the reliability determination section 318.

The image composition processing section 312 performs a WB process, a γ-process, and the like on the left image acquired by the image sensor 241, and outputs the resulting left image to the electronic zoom processing section 315. Although the first embodiment illustrates an example in which the left image is used as the image output to the display section 400, the right image may also be used as the image output to the display section 400.

### 2.2 Details of Distance Acquisition Section

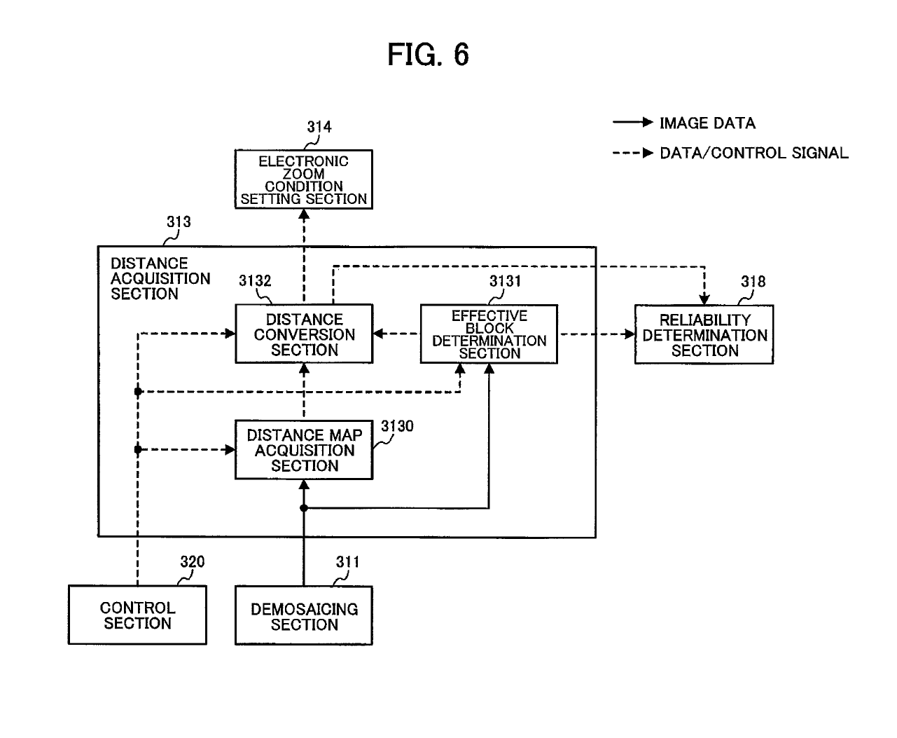

FIG. 6 illustrates the details of the distance acquisition section 313. The distance acquisition section 313 includes a distance map acquisition section 3130, an effective block determination section 3131, and a distance conversion section 3132.

The demosaicing section 311 is connected to the distance map acquisition section 3130 and the effective block determination section 3131. The distance map acquisition section 3130 is connected to the distance conversion section 3132. The effective block determination section 3131 is connected to the distance conversion section 3132 and the reliability determination section 318. The distance conversion section 3132 is connected to the electronic zoom condition setting section 314. The control section 320 is connected to the distance map acquisition section 3130, the effective block determination section 3131, and the distance conversion section 3132, and controls the distance map acquisition section 3130, the effective block determination section 3131, and the distance conversion section 3132.

The distance map acquisition section 3130 performs the stereo matching process on the stereo image output from the demosaicing section 311 to acquire the distance between the image sensor 241 and the tissue. Specifically, the distance map acquisition section 3130 performs matching calculations on the left image (hereinafter referred to as “reference image”) and a local area of the right image along an epipolar line that passes through the attention pixel of the reference image to calculate the position at which the maximum correlation is obtained as a parallax. The distance map acquisition section 3130 converts the parallax into the distance in the depth direction to acquire information that indicates the distance between the image sensor 241 and the surface of the tissue corresponding to each pixel of the left image (the information that indicates the distance between the image sensor 241 and the surface of the tissue is hereinafter referred to as “distance map”). The distance map thus generated is output to the distance conversion section 3132. Although the first embodiment illustrates an example in which the distance map is calculated using the left image as the reference image, the right image may also be used as the reference image.

In the first embodiment, since the stereo matching process is performed on a pixel basis, the acquired distance map has the same size as that of the reference image.

The distance conversion section 3132 converts the distance map output from the distance map acquisition section 3130 into a distance Dist_Now, and outputs the distance Dist_Now and the distance map to the electronic zoom condition setting section 314. The distance Dist_Now is the average value of the distance map. Note that the pixels used to calculate the average value are pixels that belong to a block that has been determined to be effective by the effective block determination section 3131 (described later). The distance Dist_Now is used to set an electronic zoom magnification Z as described later.

The effective block determination section 3131 performs an effective block determination process, and outputs effective block information (effective block determination results) to the distance conversion section 3132 and the reliability determination section 318. The reliability determination section 318 performs a determination process that utilizes the effective block information as one of the reliability determination processes (described later).

The effective block determination section 3131 sets a plurality of evaluation blocks (local areas) to the reference image, and determines whether each local area is effective or ineffective. Various index values may be used for the determination process performed on each evaluation block. For example, the contrast value, the maximum brightness (Y) value, the average brightness value, and the average color difference (Cr, Cb) value are used.

More specifically, the effective block determination section 3131 calculates the contrast value of each evaluation block. For example, a high-pass filter process may be performed on the Y signal of each pixel included in each evaluation block, and the sum of the output values may be used as the contrast value of each evaluation block.

The effective block determination section 3131 calculates the feature quantity of each evaluation block, and outputs the calculated feature quantity to the distance conversion section 3132. For example, the maximum Y signal value, the average Y signal value, the average Cb signal value, the average Cr signal value, or the like of the pixels included in each evaluation block are calculated as the feature quantity.

The effective block determination section 3131 determines whether or not each evaluation block is the effective block using the calculated index value. For example, when the calculated contrast value is equal to or larger than a given threshold value, the effective block determination section 3131 determines that the determination target evaluation block is the effective block on the assumption that the object structure that is not flat is appropriately captured (i.e., the stereo matching process is performed with a certain accuracy). When the calculated contrast value is less than the given threshold value, the effective block determination section 3131 determines that the determination target evaluation block is not the effective block on the assumption that the captured object is flat (i.e., the stereo matching process cannot be performed with sufficient accuracy).

The effective block determination section 3131 determines whether or not the maximum brightness value of each evaluation block is equal to or larger than a given threshold value, and determines that the evaluation block is not the effective block when the maximum brightness value is equal to or larger than the given threshold value on the assumption that a bright spot is included in the evaluation block, for example. The effective block determination section 3131 determines that the evaluation block is the effective block when the maximum brightness value is smaller than the given threshold value on the assumption that a bright spot is not included in the evaluation block.

The effective block determination section 3131 determines whether or not the average brightness value of each evaluation block is equal to or smaller than a given threshold value, and determines that the evaluation block is not the effective block when the average brightness value is equal to or smaller than the given threshold value on the assumption that the evaluation block is situated in a very dark area of the image, for example. The effective block determination section 3131 determines that the evaluation block is the effective block when the average brightness value is larger than the given threshold value on the assumption that the evaluation block is situated in a bright area of the image.

The effective block determination section 3131 determines whether or not both the average Cr value and the average Cb value of each evaluation block are equal to or smaller than a given threshold value, and determines that the evaluation block is not the effective block when both the average Cr value and the average Cb value are equal to or smaller than the given threshold value on the assumption that the evaluation block is situated in a forceps area of the image, for example. Specifically, since forceps are normally black or silver, both the Cb signal and the Cr signal have a value close to 0 in a forceps area of the image. The effective block determination section 3131 determines that the evaluation block is the effective block when both the average Cr value and the average Cb value (or one of the average Cr value and the average Cb value) are larger than the given threshold value on the assumption that the evaluation block is not situated in a forceps area of the image.

The effective block determination section 3131 performs one determination process among the above determination processes, or an arbitrary combination of the above determination processes, and outputs the determination result for each evaluation block. When the effective block determination section 3131 performs a plurality of determination processes, the effective block determination section 3131 may determine the evaluation block that has been determined to be the effective block by each determination process to be the effective block. The effective block determination section 3131 may determine the evaluation block that has been determined to be the ineffective block by at least one determination process to be the ineffective block.

The effective block determination section 3131 may optionally calculate an arbitrary feature quantity other than the above feature quantities, and perform an arbitrary determination process corresponding to the calculated feature quantity to determine whether or not each evaluation block is the effective block.

### 2.3 Details of Reliability Determination Section

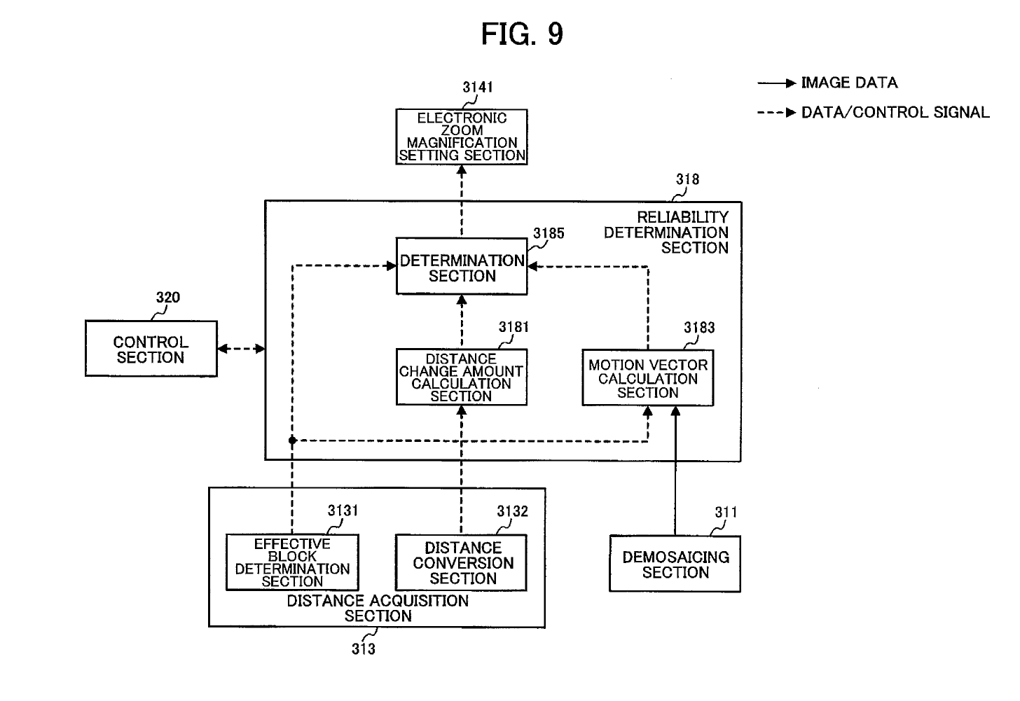

FIG. 9 illustrates the details of the reliability determination section 318. The reliability determination section 318 includes a distance change amount calculation section 3181, a motion vector calculation section 3183, and a determination section 3185.

The distance conversion section 3132 included in the distance acquisition section 313 is connected to the distance change amount calculation section 3181. The effective block determination section 3131 included in the distance acquisition section 313 is connected to the determination section 3185 and the motion vector calculation section 3183. The demosaicing section 311 is connected to the motion vector calculation section 3183. The distance change amount calculation section 3181 and the motion vector calculation section 3183 are connected to the determination section 3185. The control section 320 is connected to the distance change amount calculation section 3181, the motion vector calculation section 3183, and the determination section 3185, and controls the distance change amount calculation section 3181, the motion vector calculation section 3183, and the determination section 3185 (connection between the control section 320 and these sections is not illustrated in FIG. 9).

The distance change amount calculation section 3181 and the motion vector calculation section 3183 may form a change amount detection section (not illustrated in FIG. 9).

The distance change amount calculation section 3181 calculates the absolute difference value Dist_Diff between the distance Dist_Now output from the distance conversion section 3132 and a distance Dist_Pre that was previously acquired (acquired in the preceding frame in a narrow sense) and is stored in a distance storage section (not illustrated in FIG. 9) (that may be provided in the distance acquisition section 313 or the reliability determination section 318, for example), and outputs the absolute difference value Dist_Diff to the determination section 3185.

The motion vector calculation section 3183 detects a motion vector Vector between the image output from the demosaicing section 311 and the image in the preceding frame using the image output from the demosaicing section 311 and the image in the preceding frame, and outputs the detected motion vector Vector to the determination section 3185. A known block matching process is used as the detection process, for example. The motion vector Vector may be calculated using the entire image output from the demosaicing section 311, or may be calculated using the evaluation block that has been determined to be the effective block by the effective block determination section 3131.

The determination section 3185 determines the reliability of the distance information acquired by the distance acquisition section 313 based on the effective block information output from the effective block determination section 3131, the absolute difference value Dist_Diff output from the distance change amount calculation section 3181, and the motion vector Vector output from the motion vector calculation section 3183. The determination section 3185 may determine the reliability of the distance information by determining whether or not the distance information is reliable, or may determine the reliability of the distance information as a sequential value (e.g., a value between 0 (unreliable) and 1 (reliable)). The following description is given taking an example in which the reliability of the distance information is determined by determining whether or not the distance information is reliable.

The determination section 3185 determines the reliability of the distance information using the following methods. The determination section 3185 acquires the effective block information from the effective block determination section 3131, and determines that the distance information is unreliable when all of the evaluation blocks included in the image have been determined to be the ineffective block, or otherwise determines that the distance information is reliable. Alternatively, the determination section 3185 may calculate the ratio of the number of effective blocks to the total number of evaluation blocks in the image, and compare the calculated ratio with a given ratio threshold value. In this case, the determination section 3185 determines that the distance information is unreliable when the calculated ratio is smaller than the ratio threshold value, and determines that the distance information is reliable when the calculated ratio is equal to or larger than the ratio threshold value. Specifically, when the number of effective blocks is zero (or the ratio of the number of effective blocks is small), it is considered that the stereo matching process is not performed with high accuracy from viewpoint of the contrast value, the brightness, the color difference, or the like.

The determination section 3185 determines whether or not the distance change amount Dist_Diff is larger than a threshold value Dist_th, determines that the distance information is unreliable when the distance change amount Dist_Diff is larger than the threshold value Dist_th, and determines that the distance information is reliable when the distance change amount Dist_Diff is equal to or smaller than the threshold value Dist_th. The determination section 3185 determines whether or not the motion vector Vector is larger than a motion vector threshold value Vector_th, determines that the distance information is unreliable when the motion vector Vector is larger than the motion vector threshold value Vector_th, and determines that the distance information is reliable when the motion vector Vector is equal to or smaller than the motion vector threshold value Vector_th.

Specifically, when the distance change amount Dist_Diff or the motion vector Vector is larger than the threshold value, it is likely that an unintended motion for the doctor has occurred.

The determination section 3185 performs one determination process or two or more determination processes among the above determination processes, and outputs the determination result to the electronic zoom magnification setting section 3141 (electronic zoom condition setting section 314 in a broad sense). When the determination section 3185 performs two or more determination processes among the above determination processes, the determination section 3185 determines that the distance information is reliable when the determination result of each determination process indicates that the distance information is reliable, and determines that the distance information is unreliable when the determination result of at least one determination process indicates that the distance information is unreliable. Note that modifications may be made of the case where the determination section 3185 performs two or more determination processes among the above determination processes (described later).

### 2.4 Details of Electronic Zoom Condition Setting Section

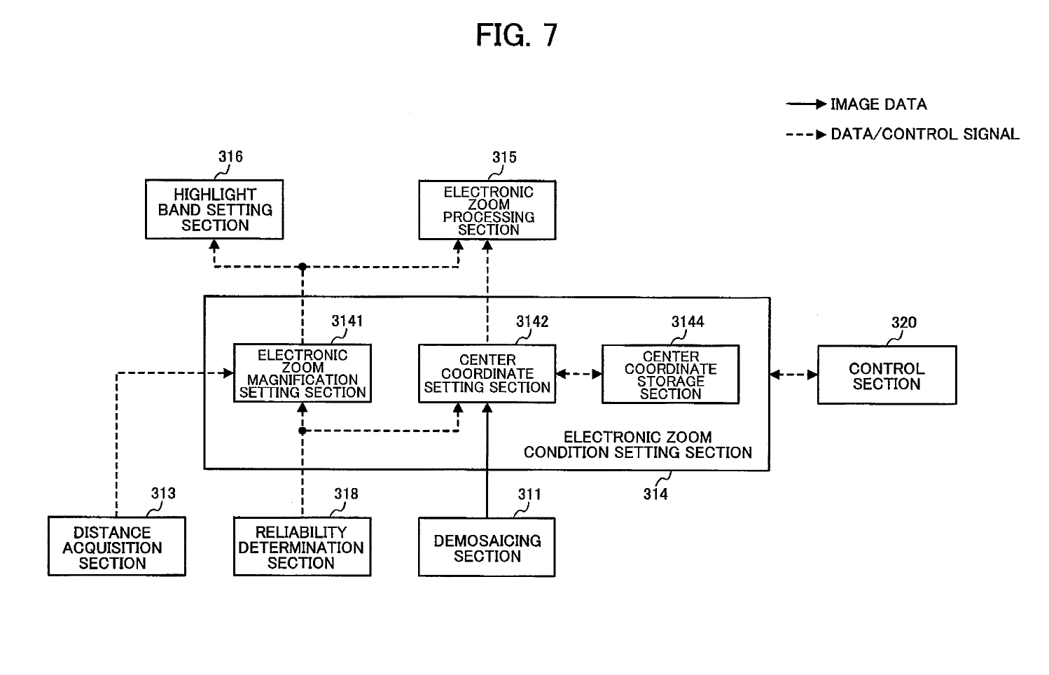

FIG. 7 illustrates the details of the electronic zoom condition setting section 314. The electronic zoom condition setting section 314 includes an electronic zoom magnification setting section 3141, a center coordinate setting section 3142, and a center coordinate storage section 3144.

The distance acquisition section 313 is connected to the electronic zoom magnification setting section 3141. The reliability determination section 318 is connected to the electronic zoom magnification setting section 3141 and the center coordinate setting section 3142. The demosaicing section 311 is connected to the center coordinate setting section 3142. The electronic zoom magnification setting section 3141 is connected to the electronic zoom processing section 315 and the highlight band setting section 316. The center coordinate setting section 3142 is connected to the electronic zoom processing section 315. The center coordinate storage section 3144 is bidirectionally connected to the center coordinate setting section 3142. The control section 320 is connected to the electronic zoom magnification setting section 3141, the center coordinate setting section 3142, and the center coordinate storage section 3144, and controls the electronic zoom magnification setting section 3141, the center coordinate setting section 3142, and the center coordinate storage section 3144 (connection between the control section 320 and these sections is not illustrated in FIG. 7).

### 2.4.1 Details of Electronic Zoom Magnification Setting Section

The electronic zoom magnification setting section 3141 calculates the distance Dist (i.e., the horizontal axis in FIGS. 10A and 10B) for calculating the electronic zoom magnification Z based on the determination result of the reliability determination section 318 to determine the electronic zoom magnification.

Specifically, the electronic zoom magnification setting section 3141 calculates the distance Dist using the following expression (1) when the distance information is unreliable. The electronic zoom magnification setting section 3141 calculates the distance Dist using the following expression (2) when the distance information is reliable.

Dist=Dist_Pre (1)

Dist=Co_{—}Z×Dist_Now+(1−Co_{—}Z)×Dist_Pre (2)

Dist_Pre is the distance Dist calculated in the preceding frame (that is not the distance Dist now calculated by the distance conversion section 3132 in the preceding frame, but is the value calculated using the expression (1) or (2) in the preceding frame). Note that modifications may be made of this configuration. A case where the distance information is unreliable corresponds to a case where an unintended motion for the doctor has occurred, or the stereo matching accuracy is low. It is considered that the electronic zoom magnification changes unnaturally when the distance Dist_Now is used to set the electronic zoom magnification. Therefore, the electronic zoom magnification is set based on the distance Dist_Pre calculated in the preceding frame (see the expression (1)) when the distance information is unreliable. Since the above problem does not occur when the distance information is reliable, the electronic zoom magnification is set based on the distance Dist_Pre calculated in the preceding frame and the distance Dist_Now acquired from the current image (see the expression (2)) when the distance information is reliable.

It is possible to suppress a rapid change in the distance Dist, and set the electronic zoom magnification in a robust manner by utilizing the distance Dist_Pre even when the distance information is reliable. In the first embodiment, the distance Dist_Now and the distance Dist_Pre are blended in a given ratio Co_Z. Co_Z is a coefficient that satisfies 0<Co_Z<1. A given value may be set as the coefficient Co_Z, or the doctor may set an arbitrary value as the coefficient Co_Z.

The electronic zoom magnification setting section 3141 outputs the distance Dist to the distance storage section (not illustrated in FIG. 7). The distance storage section s stores the distance Dist as the distance Dist_Pre that is used at a subsequent timing.

The electronic zoom magnification setting section 3141 sets the electronic zoom magnification based on the distance Dist and the in-focus object plane position output from the control section 320. Specifically, zoom observation is unnecessary when the in-focus object plane position is the far point (i.e., during screening). Therefore, the electronic zoom magnification setting section 3141 sets the electronic zoom magnification Z to a given electronic zoom magnification ZMIN (Z=ZMIN).

Since zoom observation is performed when the in-focus object plane position is the near point, the electronic zoom process is required when the scope is positioned close to the tissue. Therefore, the electronic zoom magnification is set using the calculated distance Dist. For example, the electronic zoom magnification Z is set using the following expression (3) (see FIG. 10A).

$$if ( Dist < D MIN ) Z = Z MAX \\ else if ( D MIN < Dist < D MAX ) \\ Z = Z MIN + ( Z MAX - Z MIN ) \times \frac{Dist - D MIN}{D MAX - D MIN} \\ else Z = Z MIN \qquad ( 3 )$$

In the first embodiment, the electronic zoom magnification is sequentially set within the range of ZMAX to ZMIN (ZMAX>ZMIN) corresponding to the distance Dist. For example, ZMAX is 2, and ZMIN is 1 (electronic zoom: OFF). Note that the electronic zoom magnification is not limited thereto. The values DMIN and DAX are set based on the depth of field of the objective lens 231, for example. In the first embodiment in which the depth of field when the in-focus object plane position is the near point is 5 to 15 mm, the value DMIN is set to 5 mm, and the value DMAX is set to 15 mm. The doctor may set an arbitrary value as the values ZMAX, ZMIN, DMAX, and DMIN.

According to the above method, since the distance Dist_Pre calculated in the preceding frame is referred to when an unintended motion for the user has continuously occurred, or the stereo matching accuracy is continuously low, it is possible to prevent an unnatural change in the electronic zoom magnification. Since the electronic zoom magnification is set based on the distance Dist_Now when the distance information is reliable, an appropriate electronic zoom magnification is calculated based on the distance between the scope and the tissue.

Specifically, the electronic zoom magnification is set to 1 (electronic zoom: OFF) when the distance Dist_Now (observation distance) is about 15 mm (screening), and is sequentially controlled to gradually approach 2 when the scope is moved closer to the tissue for zoom observation. This makes it unnecessary for the doctor to manually change the electronic zoom magnification, and makes it possible to minimize a change in the image due to electronic zoom.

### 2.4.2 Details of Center Coordinate Setting Section

Since the attention area is not necessarily situated at the center of the image during endoscopic diagnosis, it is necessary to adaptively control the center coordinates of the image. The center coordinate setting section 3142 sets the center coordinates (PX, PY) of the image subjected to the electronic zoom process based on the distance map output from the distance acquisition section 313 and the image output from the demosaicing section 311.

Note that the electronic zoom conditions are automatically controlled only when the in-focus object plane position of the objective lens is the near point. The center coordinates (PX, PY) are fixed (IMX/2, IMY/2) when the in-focus object plane position of the objective lens is the far point. (IMX, IMY) is the image size.

The center coordinate setting section 3142 sets the center coordinates (PX, PY) based on the reliability determination result output from the reliability determination section 318, the effective block information output from the distance acquisition section 313 (i.e., effective block determination section 3131), and the center coordinates (PX_Pre, PY_Pre) in the preceding frame output from the center coordinate storage section 3144.

The center coordinate setting section 3142 performs a different calculation process corresponding to the reliability determination result output from the reliability determination section 318 in the same manner as the electronic zoom magnification setting section 3141. Specifically, the center coordinate setting section 3142 sets the center coordinates (PX, PY) using the following expression (4) when the reliability determination section 318 has determined that the distance information is unreliable.

PX=PX_Pre

PY=PY_Pre (4)

(PX_Pre, PY_Pre) are the center coordinates calculated in the preceding frame (described later). Since it is considered that an unintended motion for the doctor has occurred, or the accuracy of the distance information (stereo matching) is low when the distance information is unreliable, the center coordinates (PX_Now, PY_Now) calculated in the current frame are not used.

When the distance information is reliable, the center coordinate setting section 3142 calculates the average coordinates of all of the blocks that have been determined to be the effective block by the effective block determination section 3131 included in the distance acquisition section 313 to be the center coordinates (PX_Now, PY_Now). The center coordinate setting section 3142 sets the center coordinates (PX, PY) using the following expression (5).

PX=Co_{—}P*PX_Now+(1−Co_{—}P)*PX_{—}Pre

PY=Co_{—}P*PY_Now+(1−Co_{—}P)*PY_Pre (5)

A given value may be set as the value Co_P, or the doctor may set an arbitrary value as the value Co_P.

The center coordinate setting section 3142 outputs the calculated center coordinates (PX, PY) to the center coordinate storage section 3144 as the center coordinates (PX_Pre, PY_Pre) used at a subsequent timing. The center coordinates (PX_Pre, PY_Pre) in the preceding frame are stored in the center coordinate storage section 3144.

It is considered that the user pays attention to an area of the image that does not correspond to a bright spot, a dark area, and a forceps area, and has high contrast (i.e., an area in which the structural component is appropriately captured). Specifically, it is possible to present an image in which the attention area is situated at the center as the image subjected to the electronic zoom process by setting the zoom center position (center coordinates) using the determination result of the effective block determination section 3131.

Note that the attention area may be determined based on whether or not a lesion area is captured, or whether or not a lesion area is situated close to the imaging section 200, for example. Various modifications may be made of the zoom center position setting process.

The attention area may be set based on the distance information. Specifically, the coordinates of the effective block for which the distance is a minimum (i.e., the effective block that is situated closest to the scope) may be set to be the center coordinates (PX_Now, PY_Now). Since an elevated lesion (e.g., tumor) is generally found in the digestive system, it is likely that the attention area (i.e., an area that is suspected to be a lesion) is elevated as compared with a normal area. Therefore, the attention area is normally situated closest to the scope during zoom observation. It is possible to present an image in which the attention area is situated at the center by setting the coordinates of the effective block that is situated closest to the scope to be the center coordinates.

The center coordinates may be set based on the weighted average of the coordinates of all of the blocks that have been determined to be the effective block by the effective block determination section 3131. The weight applied to each block may be set based on the distance. Since it is likely that the effective block that is situated close to the scope is the attention area, a large weight is applied to the effective block that is situated close to the scope.

The center coordinates (PX_Now, PY_Now) may be set based on the contrast. Specifically, the coordinates of the effective block having the highest contrast may be set to be the center coordinates (PX_Now, PY_Now). A lesion area normally has a structure in which blood vessels are closely present, and tends to have high contrast as compared with a normal area. It is possible to present an image in which the attention area is situated at the center by setting the coordinates of an area having high contrast to be the center coordinates (PX_Now, PY_Now).

The center coordinates may be set based on the weighted average of the coordinates of all of the blocks that have been determined to be the effective block by the effective block determination section 3131. The weight applied to each block may be set based on the contrast. Since it is likely that the effective block having high contrast is the attention area, a large weight is applied to the effective block having high contrast.

The center coordinates (PX_Now, PY_Now) may be set based on color information. For example, a lesion area is drawn in brown during NBI observation. Therefore, the coordinates of the block that has been determined to be the effective block by the effective block determination section 3131, and has a specific hue H, may be set to be the center coordinates (PX_Now, PY_Now).

2.5 Process Performed after Electronic Zoom Conditions have been Set

When the electronic zoom conditions have been set by the above process, the electronic zoom process and the highlight process are performed using the electronic zoom conditions.

The electronic zoom processing section 315 performs the electronic zoom process on the image output from image composition processing section 312 using the electronic zoom magnification Z output from the electronic zoom condition setting section 314, and the coordinates (PX, PY) (center coordinates) set by the center coordinate setting section 3142.

The highlight processing section 317 performs the highlight process that highlights a specific frequency band of the image output from the electronic zoom processing section 315. Since the specific frequency band is designed based on the frequency characteristics of a blood vessel and a pit pattern, the visibility of a blood vessel and a pit pattern can be improved. The highlight process is performed using a filter output from the highlight band setting section 316.

The highlight band setting section 316 sets the band (coefficient) of the filter used by the highlight processing section 317. In the first embodiment, the electronic zoom magnification is adaptively controlled as described above. Since the frequency component of the blood vessels and the pit pattern in the image changes due to the electronic zoom process (i.e., the frequency component is shifted to the low frequency side due to magnification by the electronic zoom process), the filter band is set corresponding to the change in the frequency component.

### 2.6 Details of Process

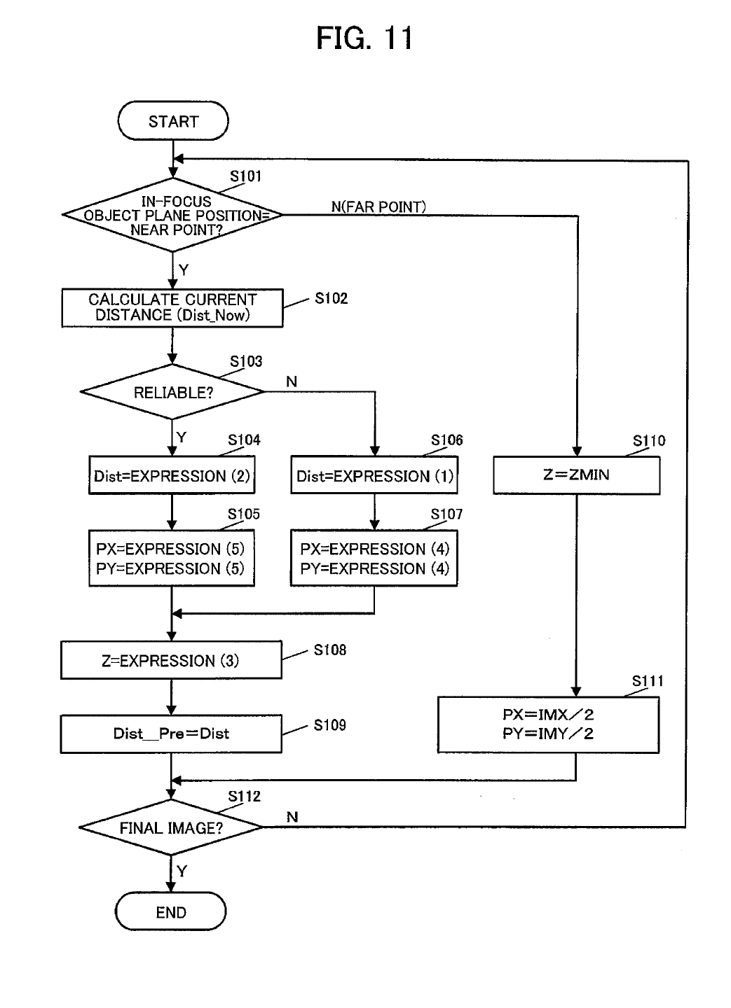

FIG. 11 is a flowchart illustrating the process according to the first embodiment. In a step S101, whether the in-focus object plane position is the near point or the far point is determined. Since the method according to the first embodiment is effective when the object is magnified by bringing the imaging section 200 close to the object (i.e., the in-focus object plane position and the depth-of-field range are situated close to the imaging section 200), the above process may be performed only when the in-focus object plane position is the near point (i.e., the above process may be skipped when the in-focus object plane position is the far point).

When the in-focus object plane position is the far point (No in S101), the electronic zoom magnification Z is set to the minimum value ZMIN (S110), and the zoom center position is set to the center position of the entire image (S111).

When the in-focus object plane position is the near point (Yes in S101), the distance acquisition section 313 acquires the distance information (the distance Dist_Now in a narrow sense). Note that the distance map and the like are also included in the distance information according to the first embodiment. The reliability of the acquired distance information is determined (S103). Specifically, the reliability of the acquired distance information is determined based on one or a combination of the distance change amount Dist_Diff, the motion vector Vector, and the effective block information.

When it has been determined that the distance information is reliable (i.e., when the distance Dist_Now can be used to calculate the distance Dist for determining the electronic zoom magnification) (Yes in S103), the distance Dist is calculated using the expression (2) (S104). Since the center coordinates (PX_Now, PY_Now) calculated at the latest timing can be used as the zoom center position, the center coordinates (PX, PY) are calculated using the expression (5) (S105).

When it has been determined that the distance information is unreliable (i.e., when it is inappropriate to use the distance Dist_Now to calculate the distance Dist for determining the electronic zoom magnification) (No in S103), the distance Dist is calculated using the expression (1) (S106). Since it is inappropriate to use the center coordinates (PX_Now, PY_Now) calculated at the latest timing as the zoom center position, the center coordinates (PX, PY) are calculated using the expression (4) (S107).

The electronic zoom magnification Z is set according to the expression (3) using the distance Dist calculated in the step S104 or S106 (S108), and the electronic zoom process is performed using the electronic zoom magnification Z and the center coordinates (PX, PY) set in the step S105 or S107.

The distance Dist_Pre is updated with the current distance Dist in preparation for a subsequent timing (S109), and whether or not the final image has been processed is determined (S112). When the final image has been processed, the process is terminated. When the final image has not been processed, the step S101 is performed again.

According to the above method, since the electronic zoom magnification is automatically controlled when the doctor has brought the scope closer to the tissue during zoom observation, the doctor need not manually change the electronic zoom magnification (i.e., the burden imposed on the doctor can be reduced). Since a situation in which the electronic zoom magnification changes to a large extent due to the pulsation of the tissue or unintended shake can be suppressed by calculating the electronic zoom magnification based on the reliability of the distance, it is possible to control the electronic zoom magnification in a robust manner.

It is also possible to reduce the burden imposed on the doctor while preventing a situation in which a lesion is missed, by setting the center coordinates (PX, PY) during the electronic zoom process so that the attention area for the doctor is situated at the center of the image (i.e., the doctor can easily observe the attention area).

### 2.7 Modifications

Although the first embodiment has been described above taking an example in which the electronic zoom conditions (electronic zoom magnification and zoom center position) are automatically controlled corresponding to the distance, the electronic zoom conditions need not necessarily always automatically controlled. For example, the doctor may select electronic zoom condition automatic control or manual control through the external I/F section 500. This makes it possible to disable electronic zoom condition automatic control when electronic zoom is not required. Alternatively, only the electronic zoom magnification may be automatically controlled while disabling zoom center position adaptive control. In this case, the zoom center position may be always set to the center of the image.

Although the first embodiment has been described above taking an example in which the in-focus object plane position is switched between the near point and the far point, the configuration is not limited thereto. The in-focus object plane position may be switched between three points or N (N>3) points. For example, an additional in-focus object plane position (middle point) may be provided between the near point and the far point.

When the in-focus object plane position is the middle point, the electronic zoom magnification may be automatically controlled, and the maximum value ZMAX of the electronic zoom magnification may be set based on the in-focus object plane position. For example, the maximum value ZMAX may be set to 2.0 when the in-focus object plane position is the far point, and may be set to 1.5 when the in-focus object plane position is the middle point.

Although the first embodiment has been described above taking an example in which the electronic zoom magnification is controlled in a robust manner using the distance Dist_Pre in the preceding frame, the configuration is not limited thereto. For example, the electronic zoom magnification may be controlled the electronic zoom magnification Z_Pre in the preceding frame may also be used. Specifically, the electronic zoom magnification Z is calculated using the following expression (6) or (7) depending on whether the distance information is unreliable or reliable. The expression (6) is used when the distance information is unreliable, and the expression (7) is used when the distance information is reliable.

Z=Z_Pre (6)

Z=Co_{—}Z*Z_Now+(1−Co_{—}Z)*Z_Pre (7)

Z_Now is the electronic zoom magnification that is set based on the distance Dist_Now calculated in the current frame, and is defined by the following expression (8).

$$if ( Dist\_Now < D MIN ) Z\_Now = Z MAX \\ else if ( D MIN < Dist\_Now < D MAX ) \\ Z\_Now = Z MIN + ( Z MAX - Z MIN ) \times \frac{Dist\_Now - D MIN}{D MAX - D MIN} \\ else Z\_Now = Z MIN \qquad ( 8 )$$

According to the above method, since the electronic zoom magnification Z_Pre set in the preceding frame is used when the distance information is unreliable, and the electronic zoom magnification Z_Now calculated from the current image is used only when the distance information is reliable, it is possible to prevent an unnatural change in the electronic zoom magnification.

The reliability of the distance information may be determined based on overall determination of each index. Specifically, the blending ratio of the distance Dist_Pre and the distance Dist_Now may be changed instead of selectively using the expression (1) or (2).

Although the first embodiment has been described above taking an example in which the reliability of the distance information is determined using the distance change amount Dist_Diff or the motion vector Vector as an index, the configuration is not limited thereto. For example, the reliability of the distance information may be determined using a combination of the distance change amount Dist_Diff and the motion vector Vector. For example, the reliability of the distance information may be determined based on an index Val calculated using the distance change amount Dist_Diff and the motion vector Vector (see the following expression (9)).

Val=C1*DistDiff+C2*Vector (9)

Although the first embodiment has been described above taking an example in which the distance Dist used to set the electronic zoom magnification Z is calculated using the expression (1) or (2), the configuration is not limited thereto. For example, the distance Dist_Pre and the distance Dist_Now may be blended based on the index Val.

Although the first embodiment has been described above taking an example in which the electronic zoom magnification Z is linearly controlled when the distance is within the range of DMIN to DMAX, the configuration is not limited thereto. For example, the electronic zoom magnification may have arbitrary characteristics (see F1 to F3 in FIG. 10B).

Although the first embodiment has been described above taking an example in which each section of the processor section 300 is implemented by hardware, the configuration is not limited thereto. For example, a CPU may perform the process of each section on the image signals and the distance acquired in advance, and the process of each section may be implemented by software by causing the CPU to execute a program. Alternatively, part of the process of each section may be implemented by software.

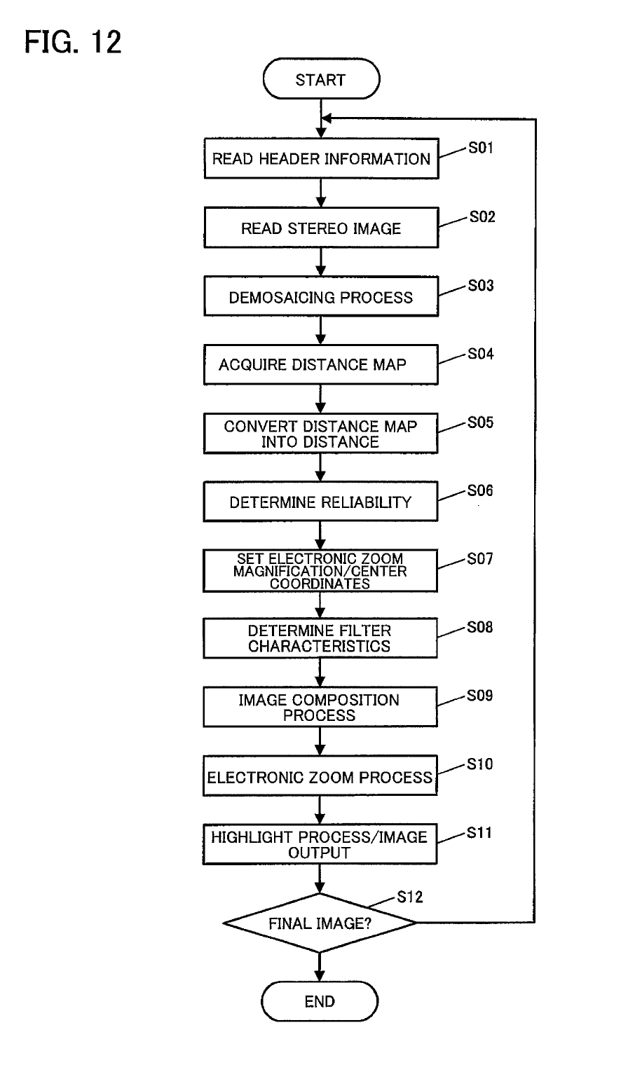

FIG. 12 illustrates the flow of the overall process. In a step S01, header information about the imaging conditions (e.g., the optical magnification of the imaging section 200 (with respect to the distance), and the distance between the image sensors 241 and 242) is read. The stereo image (left image and right image) acquired by the imaging section 200 is then read (S02).

The demosaicing process is performed on the stereo image (S03). The distance map of the reference image (left image) is acquired from the header information and the stereo image subjected to the demosaicing process using a stereo matching technique (S04). The distance map is converted into the distance Dist using the above method (i.e., the conversion process performed by the distance conversion section 3132 using the determination result of the effective block determination section 3131) (S05).

The reliability of the distance information is determined based on the distance change amount Dist_Diff of the distance Dist and the motion vector Vector (S06). The electronic zoom magnification Z and the center coordinates are set based on whether the distance information is unreliable or reliable (S07). Specifically, the distance Dist is calculated using the expression (1) when the distance information is unreliable, and calculated using the expression (2) when the distance information is reliable. The electronic zoom magnification Z is calculated using the expression (3) based on the distance Dist.

The center coordinates (PX, PY) after electronic zoom are set using the expression (4) when the distance information is unreliable, and set using the expression (5) when the distance information is reliable. The filter characteristics used for the highlight process are determined based on the electronic zoom magnification Z (S08). The WB process and the γ-process are performed on the reference image (S09). The electronic zoom process is performed on the image output in the step S09 using the electronic zoom conditions (magnification and center coordinates) that have been set as described above (S10). The highlight process is performed on the image subjected to the electronic zoom process (S10) using the filter determined in the step S08, and the resulting image is output (S11). When the above process has been performed on each image signal, the process is terminated (S12).

### 2.8 Specific Example

According to the first embodiment, the image processing device includes the image acquisition section 319 (corresponding to the demosaicing section 311 and the image composition processing section 312 in FIG. 5) that acquires an image in time series, the image having been captured by the imaging section 200, and including the object, the distance acquisition section 313 that acquires the distance information based on the distance from the imaging section 200 to the object, and links the distance information to the image, the electronic zoom condition setting section 314 that sets at least the electronic zoom magnification as the electronic zoom condition, and the electronic zoom processing section 315 that performs the electronic zoom process on the image based on the electronic zoom condition set by the electronic zoom condition setting section 314 (see FIG. 5 or 19). The electronic zoom condition setting section 314 increases the electronic zoom magnification as the distance indicated by the distance information decreases.

According to the above configuration, it is possible to increase the electronic zoom magnification used as the electronic zoom condition as the distance from the imaging section to the object decreases, and increase the magnification even when it is difficult to magnify the object by bringing the imaging section closer to the object, for example.

The image processing device may include the reliability determination section 318 that determines the reliability of the distance information, and the electronic zoom condition setting section 314 may set the electronic zoom magnification as the electronic zoom condition based on the reliability determination result (see FIG. 5).

The above configuration makes it possible to set the electronic zoom magnification based on the reliability of the distance information. The distance from the imaging section to the object also changes due to shake or the motion of the object (e.g., pulsation of tissue in the case of the endoscope system). Since such a change in distance is an unintended change for the user, it is undesirable to reflect such a change in distance in a change in zoom magnification. According to the first embodiment, the effects of an unintended motion for the user are suppressed by setting the electronic zoom magnification based on the reliability determination result.

The electronic zoom condition setting section may include a distance information storage section (not illustrated in FIG. 7 (e.g., the distance information storage section is included in the electronic zoom magnification setting section 3141)) that stores the distance information that was previously calculated as previous distance information. The electronic zoom condition setting section 314 may set the electronic zoom magnification based on the previous distance information stored in the distance information storage section when the reliability determination section 318 has determined that the reliability of the distance information is low.

According to the above configuration, it is possible to set the electronic zoom magnification at the processing target timing using the previous electronic zoom magnification when the reliability of the distance information is low (when the distance information is unreliable in a narrow sense), and suppress the effects of the distance information with low reliability on the electronic zoom magnification. The first embodiment has been described above taking an example in which the current distance information Dist_Now is not used (see expression (1)) when the reliability of the distance information is low. Note that the configuration is not limited thereto. The distance Dist_Now and the distance Dist_Pre (previous distance information) may be blended (see the expression (2)) even when the reliability of the distance information is low, and the degree of contribution of the distance Dist_Now (blending ratio Co_Z) may be set to be low as compared with the case where the reliability of the distance information is high.

The electronic zoom condition setting section may include the distance information storage section that stores the distance information that was previously calculated as the previous distance information. The electronic zoom condition setting section 314 may calculate average distance information based on the current distance information and the previous distance information stored in the distance information storage section, and set the electronic zoom magnification based on the calculated average distance information.

The electronic zoom condition setting section 314 may calculate the average distance information by calculating the weighted average of the current distance information and the previous distance information stored in the distance information storage section, and set the electronic zoom magnification based on the calculated average distance information.

According to the above configuration, since the electronic zoom magnification can be set using the average distance information calculated from the previous electronic zoom magnification (Dist_Pre) and the current electronic zoom magnification (Dist_Now), it is possible to suppress a rapid change in the electronic zoom magnification, and provide an image that is easy to observe for the user, for example. Although the first embodiment has been described above taking an example in which one piece of previous distance information is used, and the average distance information is calculated by calculating a weighted average using the blending ratio Co_Z (see the expression (2)), the configuration is not limited thereto. For example, a plurality of pieces of previous distance information may be used, and the average distance information may be calculated using a method (e.g., trim average) other than a method that calculates a weighted average (including a simple average) using the entire data. Although the first embodiment has been described above taking an example in which the electronic zoom magnification is set based on the average distance information when the reliability of the distance information is high (when the distance information is reliable in a narrow sense), the configuration is not limited thereto. For example, the electronic zoom magnification may be set based on the average distance information even when the reliability of the distance information is low. In this case, a rapid change in the electronic zoom magnification can also be suppressed as compared with the case where the electronic zoom magnification is set using only the current distance information.

The electronic zoom condition setting section 314 may include an electronic zoom magnification storage section (not illustrated in FIG. 7 (e.g., the electronic zoom magnification storage section is included in the electronic zoom magnification setting section 3141)) that stores the electronic zoom magnification that was previously calculated as a previous electronic zoom magnification. The electronic zoom condition setting section 314 may set the electronic zoom magnification based on the previous electronic zoom magnification stored in the electronic zoom magnification storage section when the reliability determination section 318 has determined that the reliability of the distance information is low.

The electronic zoom condition setting section 314 may set the electronic zoom magnification based on the current electronic zoom magnification and the previous electronic zoom magnification stored in the electronic zoom magnification storage section.

The electronic zoom condition setting section 314 may set the electronic zoom magnification by calculating a weighted average of the current electronic zoom magnification and the previous electronic zoom magnification stored in the electronic zoom magnification storage section.

According to the above configuration, the electronic zoom magnification Z can be calculated directly as described above in connection with the modification without calculating the distance information Dist used to set the electronic zoom magnification based on the reliability. The process does not substantially differ between the case of calculating the distance information Dist and the case of calculating the electronic zoom magnification Z directly (see the expressions (1) to (3) and (6) to (8)). Specifically, the modifications that may be employed when calculating the distance information Dist may also be applied to the case of calculating the electronic zoom magnification Z directly.

The reliability determination section 318 may include a change amount detection section (corresponding to the distance change amount calculation section 3181 and the motion vector calculation section 3183 in FIG. 9) that detects the amount of change in the relative positional relationship between the imaging section 200 and the object, and the reliability determination section 318 may determine the reliability based on the amount of change.

The above configuration makes it possible to determine the reliability corresponding to the amount of change in the relative positional relationship between the imaging section 200 and the object. It is considered that the user closely observe a narrow area of the object during zoom observation to which the method according to the first embodiment is applied. Since it is not likely that the user intentionally moves the imaging section 200 to a large extent in such a situation, it is considered that a case where a change in the relative positional relationship between the imaging section 200 and the object has occurred due to a rapid motion of at least one of the imaging section 200 and the object is an unintended situation for the user. Therefore, the amount of such a change in relative positional relationship is detected, and the reliability is determined based on the amount of change.

The change amount detection section may detect the amount of temporal change in the distance between the imaging section 200 and the object indicated by the distance information as the amount of change.

In this case, the change amount detection section corresponds to the distance change amount calculation section 3181 illustrated in FIG. 9.

The above configuration makes it possible to determine the reliability based on a change in the distance between the imaging section 200 and the object. The reliability decreases as the amount of change increases, as described above. In the above case, the reliability is determined based on a change in the optical axis direction of the imaging section (i.e., a change in distance).

The change amount detection section may detect the motion amount of the object within the image as the amount of change based on a plurality of images acquired at different timings.

In this case, the change amount detection section corresponds to the motion vector calculation section 3183 illustrated in FIG. 9.

The above configuration makes it possible to determine the reliability based on the motion vector that indicates the motion of the object. The reliability decreases as the amount of change increases, as described above. In the above case, the reliability is determined based on a change in the direction orthogonal to the optical axis direction of the imaging section.

When the image acquisition section acquires a stereo image as the image, and the distance acquisition section 313 acquires the distance information by performing the stereo matching process on the stereo image, the reliability determination section 318 may determine the reliability of the distance information based on the contrast detected from the image.

In the first embodiment, the effective block determination section 3131 included in the distance acquisition section 313 performs the effective block determination process based on the contrast, and the reliability determination section 318 determines the reliability based on the effective block information obtained by the effective block determination process. Specifically, the effective block determination process is performed taking account of the fact that the effective block information is also used when the pixels used for the process performed by the distance conversion section 3132 are determined, and when the center coordinate setting section 3142 sets the zoom center position. This means that it may be unnecessary to use the effective block determination result of the effective block determination section 3131 included in the distance acquisition section 313, and the reliability determination section 318 may include a contrast calculation section.

The above configuration makes it possible to determine the reliability based on the contrast of the image when utilizing the stereo matching process. Specifically, a matching process must be performed on the right image and the left image when utilizing the stereo matching process. However, it may be difficult to perform the matching process with high accuracy when the image has low contrast, and the accuracy of the acquired distance information may be low.

The electronic zoom condition setting section 314 may include the electronic zoom magnification storage section that stores the electronic zoom magnification that was previously calculated as the previous electronic zoom magnification, and the electronic zoom condition setting section 314 may set the electronic zoom magnification based on the previous electronic zoom magnification stored in the electronic zoom magnification storage section.

According to the above configuration, a rapid change in the electronic zoom magnification can be suppressed using the previous electronic zoom magnification without providing the reliability determination section 318. It is desirable to determine the reliability of the distance information when pursuing accuracy. However, since the effects of the electronic zoom magnification acquired from the current distance information can be reduced by utilizing at least the previous electronic zoom magnification, it is possible to suppress a rapid change in the electronic zoom magnification to a certain extent while reducing the processing load as compared with the case of determining the reliability of the distance information.

When the imaging section 200 includes a movable lens that can be set at a plurality of lens positions that differ in in-focus object plane position, and the in-focus object plane position is controlled by driving the movable lens using a lens driver section, the electronic zoom condition setting section 314 may set the electronic zoom condition based on the distance information when the in-focus object plane position is closer to the imaging section 200 than a given threshold value.

The term “in-focus object plane position” used herein refers to the position (object point) of the object relative to a reference position when a system including the object, the imaging optical system, the image plane, and the like is in an in-focus state. Specifically, when the image plane is set at a given position, and the imaging optical system is set to a given state, the in-focus object plane position refers to the position of the object when the image formed in the image plane through the imaging optical system is in focus. Since the image processing device (or the endoscope system) and the like according to the first embodiment are designed on the assumption that the image plane coincides with the plane of the image sensor included in the imaging section, the in-focus object plane position can be determined by determining the state of the optical system when the plane of the image sensor is fixed.

According to the above configuration, when the imaging section 200 includes a movable lens, the method according to the first embodiment can be applied when the movable lens is set at the lens position at which the in-focus object plane position is closer to the imaging section (i.e., when it is considered that zoom observation is performed by bringing the imaging section 200 closer to the object). Since it may not be necessary to increase the magnification using the electronic zoom process when it is considered that zoom observation is not performed, and a change in magnification that is not desired for the user may occur as a result of automatically controlling the electronic zoom magnification, it is important to appropriately determine whether to enable or disable the electronic zoom process. Note that the electronic zoom process need not necessarily be enabled or disabled. For example, the user may determine whether to enable or disable the electronic zoom process.

The lens driver section may control the in-focus object plane position stepwise by selecting a lens position from a given number of lens positions.

The above configuration makes it possible to implement the process according to the first embodiment on signals output from the imaging section that controls the movable lens between discrete lens positions. The given number of lens positions may be two lens positions (i.e., far point and near point) (see FIG. 4), or may be three or more lens positions (see the modification).

The lens driver section may move the movable lens to a first lens position or a second lens position, the first lens position being a lens position at which the in-focus object plane position is the near point, and the second lens position being a lens position at which the in-focus object plane position is the far point that is a point farther from the imaging section 200 than the near point, and the electronic zoom condition setting section 314 may set the electronic zoom condition based on the distance information when the in-focus object plane position is the near point.

According to the above configuration, when using an imaging device that includes a dual-focus optical system as illustrated in FIG. 4, the process according to the first embodiment can be applied when the in-focus object plane position is the near point. As described above, it is likely that zoom observation is performed when the in-focus object plane position is the near point (i.e., when the distance from the imaging section 200 to the object is short).

The electronic zoom condition setting section 314 may set the electronic zoom magnification to a first given magnification when the distance indicated by the distance information is shorter than a first distance. The first distance may be determined based on the distance at the endpoint of the depth-of-field range of the imaging section 200 that is closer to the imaging section 200.

The above configuration makes it possible to set a given value to be the electronic zoom magnification when the distance from the imaging section 200 to the object is shorter than the first distance. The first distance may be determined based on the endpoint of the depth-of-field range. When the distance from the imaging section 200 to the object is so short that the object lies outside the depth-of-field range, it is not effective to perform the electronic zoom process by applying the method according to the first embodiment since the object is not brought into focus (i.e., a defocused image is acquired). Therefore, the electronic zoom magnification is set using the first distance determined from the depth-of-field range. In the examples illustrated in FIGS. 10A and 10B, the first distance corresponds to DMIN, and the first given magnification corresponds to ZMAX.

The electronic zoom condition setting section 314 may set the electronic zoom magnification to a second given magnification when the distance indicated by the distance information is longer than a second distance. The second distance may be determined based on the distance at the endpoint of the depth-of-field range of the imaging section 200 that is farther from the imaging section 200.

The above configuration makes it possible to perform the above process even when the distance from the imaging section 200 to the object is longer than the second distance. When the second distance is determined based on the endpoint of the depth-of-field range, the electronic zoom condition setting process in a state in which the object is out of focus is skipped in the same manner as in the case of the first distance. In the examples illustrated in FIGS. 10A and 10B, the second distance corresponds to DMAX, and the second given magnification corresponds to ZMIN.

The electronic zoom condition setting section 314 may set the zoom center position (center coordinates) used for the electronic zoom process as the electronic zoom condition. The electronic zoom condition setting section 314 may set the zoom center position based on at least one of the image and the distance information.

The above configuration makes it possible to set the zoom center position in addition to the electronic zoom magnification, and prevent a situation in which the attention area is missing from the image subjected to the electronic zoom process even when the attention area is situated in the peripheral area of the image (see FIGS. 8C and 8E). In the first embodiment, since the zoom center position is set based on the effective block information, the zoom center position is set based on the brightness, the color difference (Cr, Cb), the contrast, or the like of the image. Note that the configuration is not limited thereto. For example, the object that is situated closer to the imaging section 200 may be determined to be more important. In this case, the zoom center position is set based on the distance information.

The image processing device may include an attention area detection section that detects an attention area from the image, and the electronic zoom condition setting section 314 may set the zoom center position based on the attention area detected by the attention area detection section.

The above configuration makes it possible to set the zoom center position based on the attention area. The attention area detection section may be the effective block determination section 3131. In this case, the attention area is an area that corresponds to the effective block, and the process that sets the zoom center position based on the attention area corresponds to the process that calculates the average coordinates of the effective block. Note that the attention area detection section is not limited to the effective block determination section 3131. For example, an endoscope system may utilize a technique that detects the attention area (lesion area) through observation using special light (e.g., narrow band imaging (NBI)), a technique that detects unnecessary areas (e.g., bubble area and residue area) from the image, and determines the area other than the unnecessary areas to be the attention area, and the like. The attention area may be detected by utilizing these techniques. When using an imaging device other than an endoscope system, a template of a specific object may be stored, and the specific object may be detected from the image to detect the attention area.

The image processing device may include the highlight processing section 317 that performs the highlight process on the image subjected to the electronic zoom process (see FIG. 5), and the highlight processing section 317 may perform the highlight process based on the electronic zoom magnification set by the electronic zoom condition setting section 314.

The above configuration makes it possible to implement the highlight process based on the electronic zoom magnification. For example, when the highlight process is performed that improves the visibility of the object by highlighting a specific frequency band, since the frequency characteristics of the object change along with a change in the electronic zoom magnification, it may be ineffective to highlight a fixed frequency band. When the highlight process is performed based on the electronic zoom magnification, it is possible to specify a change in the frequency characteristics of the highlight target object due to the electronic zoom process. Therefore, an effective highlight process can be implemented.

The image acquisition section may acquire a stereo image as the image, and the distance acquisition section 313 may acquire the distance information by performing a stereo matching process on the stereo image.

The above configuration makes it possible to acquire the distance information by stereo matching.

Note that part or most of the processes performed by the image processing device and the like according to the first embodiment may be implemented by a program. In this case, the image processing device and the like according to the first embodiment are implemented by causing a processor (e.g., CPU) to execute a program. Specifically, a program stored in a non-transitory information storage device is read from the information storage device, and a processor (e.g., CPU) executes the program read from the information storage device. The information storage device (computer-readable device) stores a program, data, and the like. The function of the information storage device may be implemented by an optical disk (e.g., DVD or CD), a hard disk drive (HDD), a memory (e.g., memory card or ROM), or the like. The processor (e.g., CPU) performs various processes according to the first embodiment based on a program (data) stored in the information storage device. Specifically, a program that causes a computer (i.e., a device including an operation section, a processing section, a storage section, and an output section) to function as each section according to the first embodiment (i.e., a program that causes a computer to execute the process implemented by each section) is stored in the information storage device.

The image processing device and the like according to the embodiments of the invention may include a processor and a memory. The processor may be a central processing unit (CPU), for example. Note that the processor is not limited to a CPU. Various types of processors such as a graphics processing unit (GPU) and a digital signal processor (DSP) may also be used. The processor may be a hardware circuit such as an application specific integrated circuit (ASIC). The memory stores a computer-readable instruction. Each section of the image processing device and the like according to the embodiments of the invention is implemented by causing the processor to execute the instruction. The memory may be a semiconductor memory (e.g., SRAM or DRAM), a register, a hard disk, or the like. The instruction may be an instruction included in an instruction set of a program, or may be an instruction that causes a hardware circuit of the processor to operate.

### 3. Second Embodiment

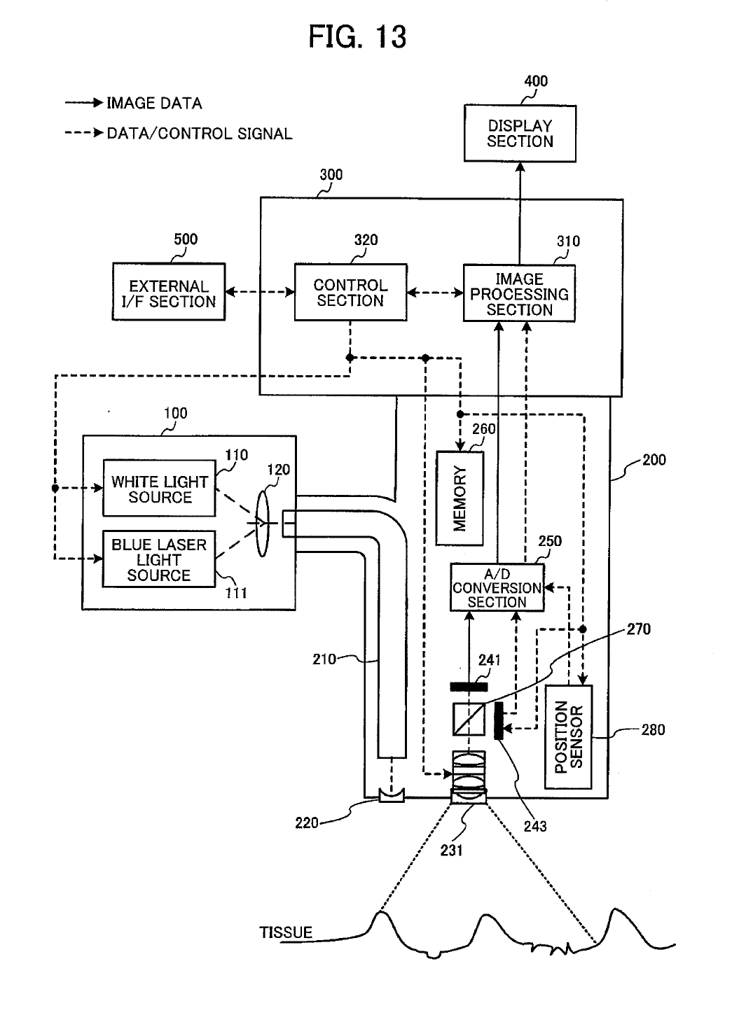

An endoscope system that includes an image processing device according to the second embodiment is described below with reference to FIG. 13. The endoscope system according to the second embodiment includes a light source section 100, an imaging section 200, a processor section 300, a display section 400, and an external I/F section 500. Note that the display section 400 and the external OF section 500 are configured in the same manner as described above in connection with the first embodiment, and description thereof is omitted.

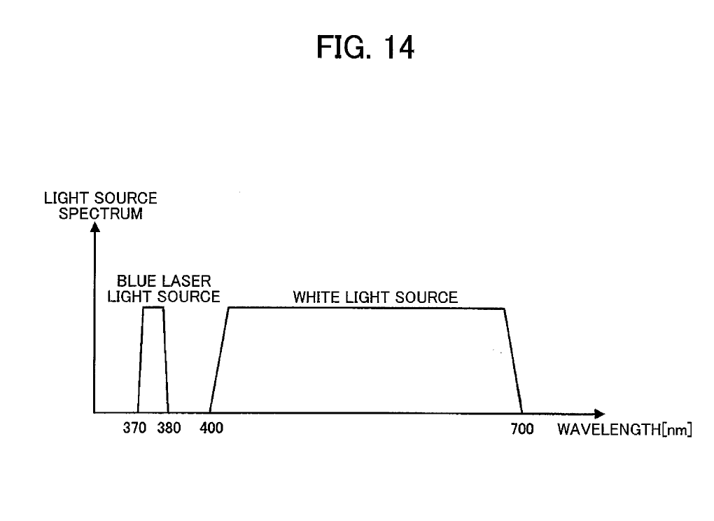

The light source section 100 includes a white light source 110, a blue laser light source 111, and a condenser lens 120 that focuses light obtained by synthesizing light emitted from the white light source 110 and light emitted from the blue laser light source 111 on a light guide fiber 210. The white light source 110 and the blue laser light source 111 are controlled in a pulsed manner based on a control signal output from the control section 320. As illustrated in FIG. 14, the white light source 110 emits light within a band from 400 to 700 nm, and the blue laser light source 111 emits light within a band from 370 to 380 nm, for example.

The imaging section 200 includes the light guide fiber 210, an illumination lens 220, an objective lens 231, an image sensor 241, a ranging sensor 243, an A/D conversion section 250, a memory 260, a dichroic prism 270, and a position sensor 280. Note that the light guide fiber 210, the illumination lens 220, the objective lens 231, the image sensor 241, and the memory 260 are configured in the same manner as described above in connection with the first embodiment, and description thereof is omitted.

The dichroic prism 270 reflects short-wavelength light having a wavelength of 370 to 380 nm that corresponds to the spectrum of the blue laser light source 111, and allows light having a wavelength of 400 to 700 nm that corresponds to the wavelength of the white light source 110 to pass through. The short-wavelength light reflected by the dichroic prism 270 (i.e., the light emitted from the blue laser light source 111, and reflected by the object) is detected by the ranging sensor 243. The light that has passed through the dichroic prism 270 (i.e., the light emitted from the white light source 110, and reflected by the object) is imaged by the image sensor 241. The ranging sensor 243 is a Time-of-Flight ranging sensor that measures distance based on the time from the blue laser light emission start timing to the reflected light (reflected blue laser light) detection timing. Information about the blue laser light emission start timing is supplied from the control section 320 (described later).

The A/D conversion section 250 converts a distance map acquired by the ranging sensor 243 into digital signals, and outputs the digital signals to the image processing section 310 (described later). The position sensor 280 detects the motion amount (motion vector) of the end of the imaging section 200, and outputs the detected motion vector to the A/D conversion section 250. The A/D conversion section 250 converts the motion vector into digital signals, and outputs the digital signals to the image processing section 310 (described later).

Specifically, the second embodiment differs from the first embodiment in that the distance map and the motion vector are respectively detected using the ranging sensor 243 and the position sensor 280.

The processor section 300 includes an image processing section 310 and the control section 320. The image processing section 310 performs image processing (described later) on the image output from the A/D conversion section 250 to generate a display image, and outputs the generated display image to the display section 400. The control section 320 controls the operation of the image processing section 310 based on a signal output from the external I/F section 500 (described later). The control section 320 is connected to the white light source 110, the blue laser light source 111, and the ranging sensor 243, and controls the white light source 110, the blue laser light source 111, and the ranging sensor 243.

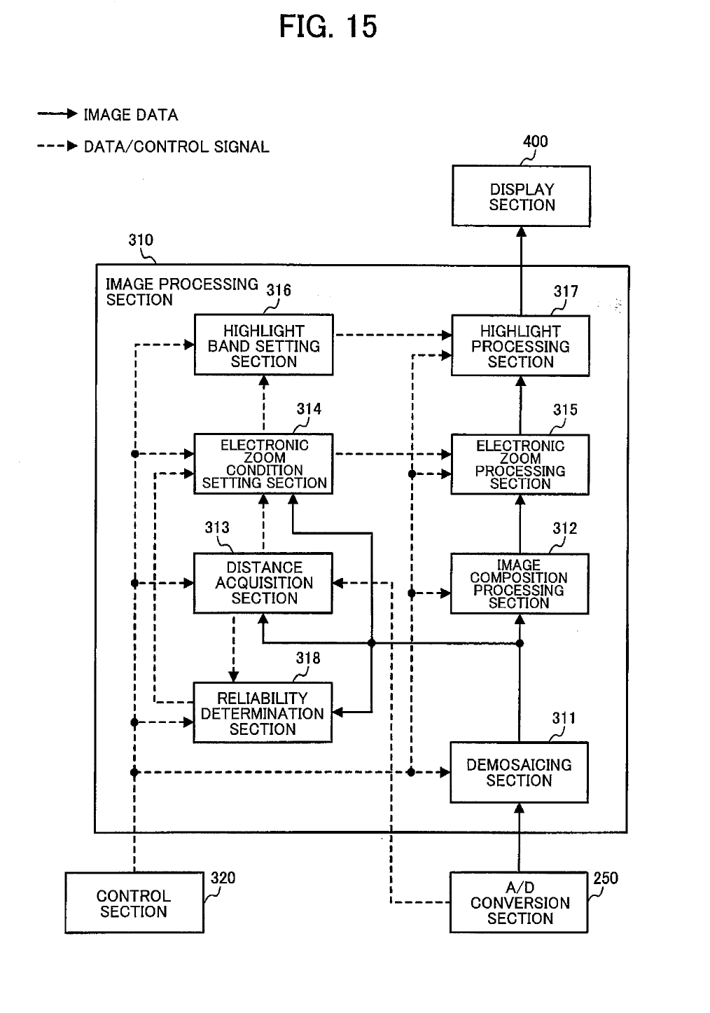

The details of the image processing section 310 are described below with reference to FIG. 15. The image processing section 310 includes a demosaicing section 311, an image composition processing section 312, a distance acquisition section 313, an electronic zoom condition setting section 314, an electronic zoom processing section 315, a highlight band setting section 316, a highlight processing section 317, and a reliability determination section 318. Note that the demosaicing section 311, the image composition processing section 312, the electronic zoom processing section 315, the highlight band setting section 316, and the highlight processing section 317 are configured in the same manner as described above in connection with the first embodiment, and description thereof is omitted. The A/D conversion section 250 is connected to the demosaicing section 311 and the distance acquisition section 313. The connection relationship other than the above connection relationship is the same as described above in connection with the first embodiment.

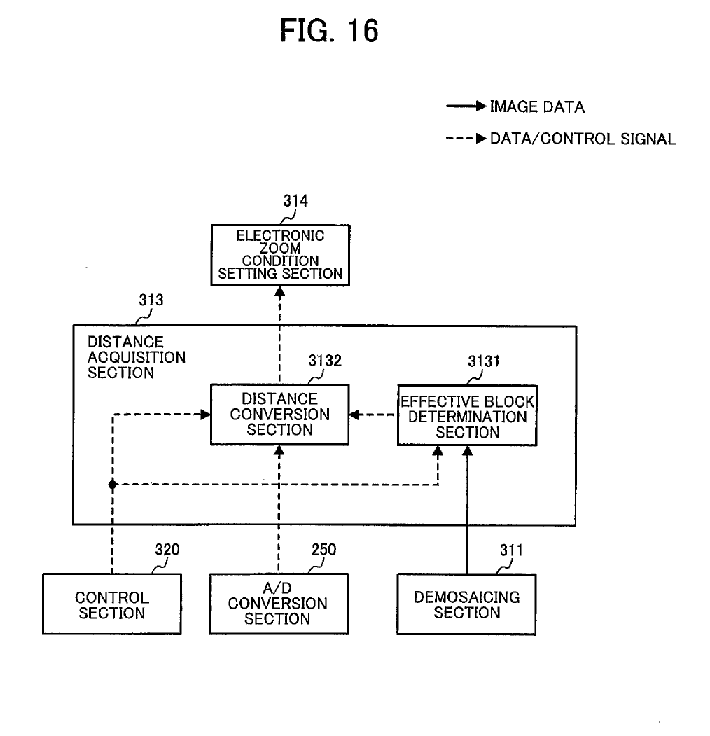

FIG. 16 illustrates the configuration of the distance acquisition section 313. The distance acquisition section 313 is configured in the same manner as described above in connection with the first embodiment, except that the distance map acquisition section 3130 is omitted. The A/D conversion section 250 is connected to the distance conversion section 3132. The demosaicing section 311 is connected to the effective block determination section 3131. The connection relationship other than the above connection relationship and the process performed by each section are the same as described above in connection with the first embodiment. In the second embodiment, the distance information is acquired from the ranging sensor 243 as sensor information, and the sensor information is processed directly by the distance conversion section 3132.

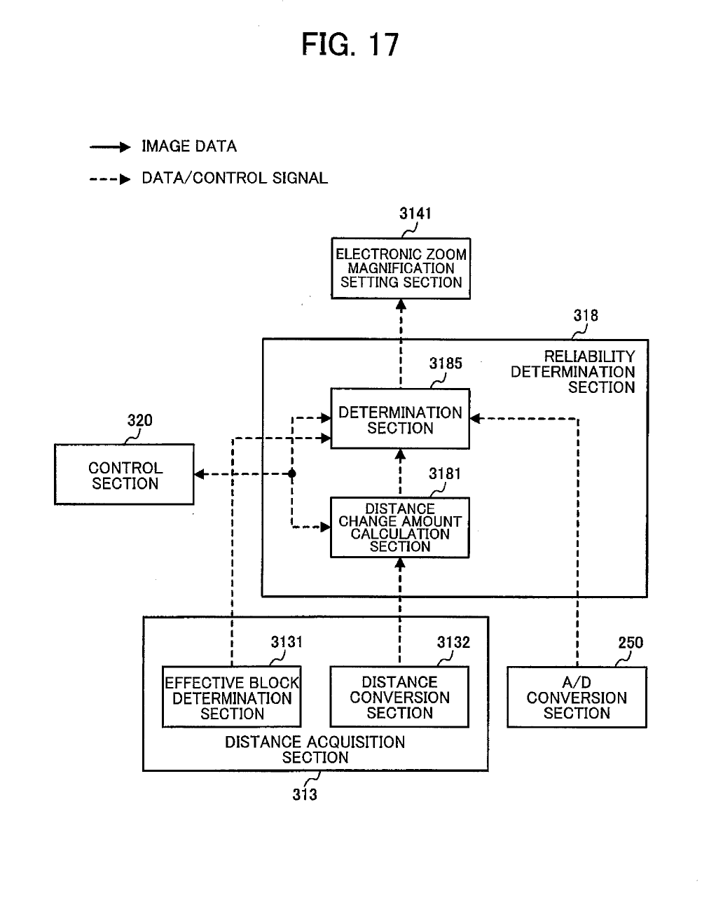

FIG. 17 illustrates the configuration of the reliability determination section 318. The reliability determination section 318 is configured in the same manner as described above in connection with the first embodiment, except that the motion vector calculation section 3183 is omitted. The A/D conversion section 250 is connected to the determination section 3185. The motion vector obtained by converting the sensor information from the position sensor 280 into digital signals is output from the A/D conversion section 250. The connection relationship other than the above connection relationship and the process performed by each section are the same as described above in connection with the first embodiment.

The reliability of the distance information is determined based on the effective block information output from the effective block determination section 3131, the distance change amount Dist_Diff calculated by the distance change amount calculation section 3181, and the motion vector Vector in the same manner as described above in connection with the first embodiment. Note that the motion vector Vector used in the second embodiment is the sensor information that has been output from the position sensor 280 and converted by the A/D conversion section 250.

The electronic zoom condition setting section 314 is configured in the same manner as described above in connection with the first embodiment (see FIG. 7). The electronic zoom magnification setting section 3141 calculates the distance Dist using the expression (1) or (2) based on the determination result of the reliability determination section 318, and sets the electronic zoom magnification using the distance Dist. The center coordinate setting section 3142 calculates the center coordinates (PX, PY) using the expression (4) or (5) based on the determination result of the reliability determination section 318. The details thereof are the same as described above in connection with the first embodiment.

According to the above method, since the electronic zoom magnification is automatically controlled when the doctor has brought the scope closer to the tissue during zoom observation, the doctor need not manually change the electronic zoom magnification (i.e., the burden imposed on the doctor can be reduced). Since a situation in which the electronic zoom magnification changes to a large extent due to the pulsation of the tissue or unintended shake can be suppressed by calculating the electronic zoom magnification based on the reliability of the distance, it is possible to control the electronic zoom magnification in a robust manner.

It is also possible to reduce the burden imposed on the doctor while preventing a situation in which a lesion is missed, by setting the center coordinates (PX, PY) during the electronic zoom process so that the attention area for the doctor is situated at the center of the image (i.e., the doctor can easily observe the attention area).

According to the second embodiment, the distance and the motion amount can be acquired using the ranging sensor 243 and the position sensor 280 (e.g., a motion sensor such as an acceleration sensor). Therefore, the processor section 300 need not perform the stereo matching process, the block matching process, or the like, and the scale (cost) of the processor section 300 can be reduced.

Although the second embodiment has been described above taking an example in which each section of the processor section 300 is implemented by hardware, the configuration is not limited thereto. For example, a CPU may perform the process of each section on the image signals and the distance acquired in advance, and the process of each section may be implemented by software by causing the CPU to execute a program. Alternatively, part of the process of each section may be implemented by software.

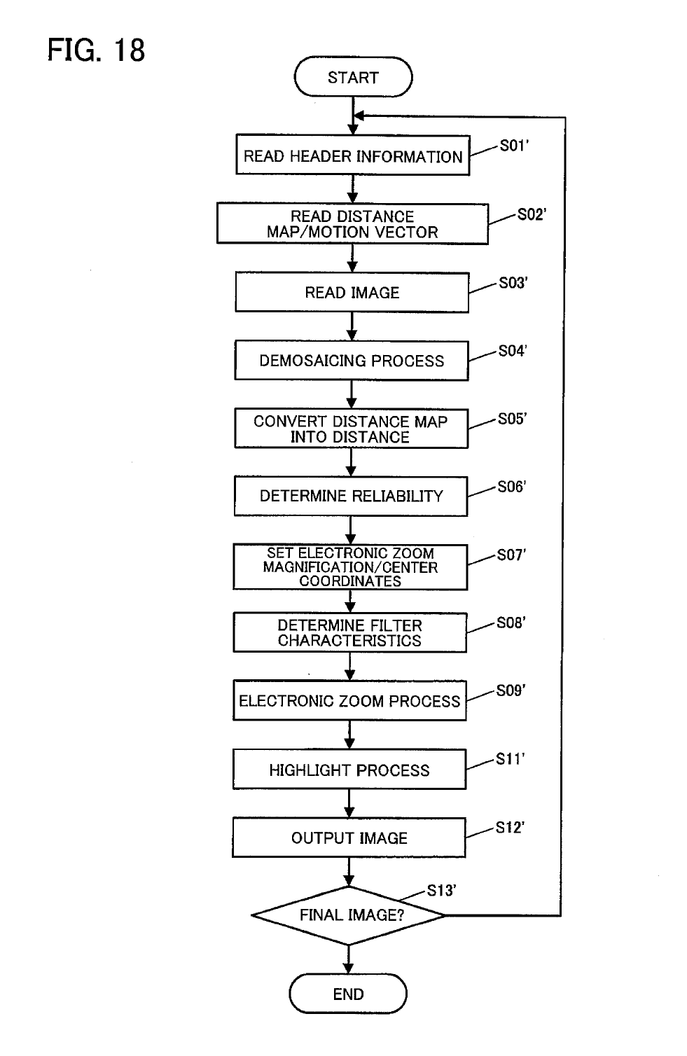

FIG. 18 illustrates the flow of the overall process. In a step S01′, the imaging conditions (e.g., the optical magnification of the imaging section (with respect to the distance), and the distance between the image sensors) are read. The header information about the distance map acquired by the ranging sensor 243 and the motion vector acquired by the position sensor 280 is read (S02′). The image acquired by the imaging section is then read (S03′), and subjected to the demosaicing process (S04′). The subsequent process is the same as described above in connection with the first embodiment.

In the second embodiment, some of the processes may not utilize the effective block determination result. For example, since the distance information is acquired from the ranging sensor 243 in the second embodiment, a decrease in accuracy of the distance information does not occur directly due to a dark area or a bright spot within the image, or a low contrast value of the image (e.g., when the object is flat). Specifically, the distance conversion section 3132 may be able to calculate an appropriate distance (Dist_Now) without using the effective block information. When implementing an endoscope system, however, since the second embodiment aims to control the zoom magnification corresponding to the distance from the imaging section 200 to the object (tissue), it is inappropriate to use the distance to forceps. Specifically, it may be useful to perform the effective block determination process on forceps using the average (Cr, Cb) value or the like.

In the first embodiment, the reliability determination section 318 determines the reliability of the distance information using the effective block information since the accuracy of the acquired distance information is low when the contrast value is low, or a dark area or a bright spot is present. Specifically, the reliability determination section 318 may determine the reliability of the distance information without using the effective block information when the distance information with sufficient accuracy is acquired from the ranging sensor 243.

Note that the process performed by the center coordinate setting section 3142 is based on the assumption that the user pays attention to an area having high contrast, an area other than a dark area and a bright spot, and an area other than a forceps area. Specifically, it is desirable that the center coordinate setting section 3142 perform the process using the effective block information in the same manner as described above in connection with the first embodiment.

Although the second embodiment has been described above taking an example in which the distance conversion section 3132, the reliability determination section 318, and the center coordinate setting section 3142 utilize the effective block information that is obtained using the information about the contrast value, a dark area, a bright spot, and forceps (i.e., the effective block information that is obtained using the contrast value, the average brightness value, the maximum brightness value, and the average Cr/Cb value) in the same manner as described above in connection with the first embodiment, the configuration is not limited thereto. For example, the center coordinate setting section 3142 may utilize the effective block information, but the distance conversion section 3132 and the reliability determination section 318 may not utilize the effective block information. In this case, the effective block determination section may be included in the electronic zoom condition setting section 314 instead of the distance acquisition section 313 (see FIG. 16). Alternatively, the center coordinate setting section 3142 may utilize the results of the effective block determination process based on all of the contrast value, a dark area, a bright spot, and forceps, and the distance conversion section 3132 and the reliability determination section 318 may utilize the results of the effective block determination process based on only forceps.

According to the second embodiment, the change amount detection section detects the amount of change based on sensor information output from a sensor included in the imaging section 200.

The sensor included in the imaging section 200 may be the position sensor 280 and/or the ranging sensor 243.

According to the above configuration, the distance information can be calculated from the sensor information output from the ranging sensor 243, and the amount of change can be calculated from the difference in distance instead of calculating the distance information by stereo matching, and calculating the amount of change from the difference in distance as described above in connection with the first embodiment. Moreover, the motion vector Vector can be calculated from the sensor information output from the position sensor 280 instead of calculating the motion vector Vector from the image as described above in connection with the first embodiment. Although it is necessary to provide additional hardware (sensor) when employing the above configuration, the amount of change can be detected directly from the sensor information, or detected from the sensor information through a simple conversion process. This makes it possible to reduce the processing load as compared with the first embodiment.

The distance acquisition section 313 may acquire the distance information based on a ranging signal from the ranging sensor 243 included in the imaging section 200.

The above configuration makes it possible to It acquire the distance information using the ranging sensor 243. The advantages obtained by utilizing the ranging sensor 243 have been described above.

The first embodiment and the second embodiment according to the invention and the modifications thereof have been described above. Note that the invention is not limited thereto. Various modifications and variations may be made of the first embodiment, the second embodiment, and the modifications thereof without departing from the scope of the invention. A plurality of elements described in connection with the first embodiment, the second embodiment, and the modifications thereof may be appropriately combined to implement various configurations. For example, an arbitrary element may be omitted from the elements described in connection with the first embodiment, the second embodiment, and the modifications thereof. Some of the elements described above in connection with different embodiments or modifications thereof may be appropriately combined. Any term cited with a different term having a broader meaning or the same meaning at least once in the specification and the drawings can be replaced by the different term in any place in the specification and the drawings. Specifically, various modifications and applications are possible without materially departing from the novel teachings and advantages of the invention.

What is claimed is:

1. An image processing device comprising:
an image acquisition section that acquires an image in time series, the image having been captured by an imaging section, and including an object;
a distance acquisition section that acquires distance information based on a distance from the imaging section to the object;
an electronic zoom condition setting section that sets at least an electronic zoom magnification as an electronic zoom condition, the electronic zoom condition being a condition for an electronic zoom process; and
an electronic zoom processing section that performs the electronic zoom process on the image based on the electronic zoom condition,
the electronic zoom condition setting section increasing the electronic zoom magnification as the distance indicated by the distance information decreases with respect to a given depth of field of the imaging section.

2. The image processing device as defined in claim 1, further comprising:
a reliability determination section that determines reliability of the distance information,
the electronic zoom condition setting section setting the electronic zoom magnification as the electronic zoom condition based on a reliability determination result of the reliability determination section.

3. The image processing device as defined in claim 2,
the electronic zoom condition setting section including a distance information storage section that stores the distance information that was previously calculated as previous distance information, and
the electronic zoom condition setting section setting the electronic zoom magnification based on the previous distance information stored in the distance information storage section when the reliability determination section has determined that the reliability of the distance information is low.

4. The image processing device as defined in claim 2,
the electronic zoom condition setting section including a distance information storage section that stores the distance information that was previously calculated as previous distance information, and
the electronic zoom condition setting section calculating average distance information based on current distance information and the previous distance information stored in the distance information storage section, and setting the electronic zoom magnification based on the calculated average distance information.

5. The image processing device as defined in claim 4,
the electronic zoom condition setting section calculating the average distance information by calculating a weighted average of the current distance information and the previous distance information stored in the distance information storage section, and setting the electronic zoom magnification based on the calculated average distance information.

6. The image processing device as defined in claim 2,
the electronic zoom condition setting section including an electronic zoom magnification storage section that stores the electronic zoom magnification that was previously calculated as a previous electronic zoom magnification, and
the electronic zoom condition setting section setting the electronic zoom magnification based on the previous electronic zoom magnification stored in the electronic zoom magnification storage section when the reliability determination section has determined that the reliability of the distance information is low.

7. The image processing device as defined in claim 2,
the electronic zoom condition setting section including an electronic zoom magnification storage section that stores the electronic zoom magnification that was previously calculated as a previous electronic zoom magnification, and
the electronic zoom condition setting section setting the electronic zoom magnification based on a current electronic zoom magnification and the previous electronic zoom magnification stored in the electronic zoom magnification storage section.

8. The image processing device as defined in claim 7,
the electronic zoom condition setting section setting the electronic zoom magnification by calculating a weighted average of the current electronic zoom magnification and the previous electronic zoom magnification stored in the electronic zoom magnification storage section.

9. The image processing device as defined in claim 2,
the reliability determination section including a change amount detection section that detects an amount of change in relative positional relationship between the imaging section and the object, and
the reliability determination section determining the reliability of the distance information based on the amount of change.

10. The image processing device as defined in claim 9,
the change amount detection section detecting an amount of temporal change in the distance between the imaging section and the object indicated by the distance information as the amount of change.

11. The image processing device as defined in claim 9,
the change amount detection section detecting a motion amount of the object within the image as the amount of change based on a plurality of the images acquired at different timings.

12. The image processing device as defined in claim 9,
the change amount detection section detecting the amount of change based on sensor information output from a sensor included in the imaging section.

13. The image processing device as defined in claim 2,
the image acquisition section acquiring a stereo image as the image, and the distance acquisition section acquiring the distance information by performing a stereo matching process on the stereo image, and
the reliability determination section determining the reliability of the distance information based on a contrast detected from the image.

14. The image processing device as defined in claim 1,
the electronic zoom condition setting section including an electronic zoom magnification storage section that stores the electronic zoom magnification that was previously calculated as a previous electronic zoom magnification, and
the electronic zoom condition setting section setting the electronic zoom magnification based on the previous electronic zoom magnification stored in the electronic zoom magnification storage section.

15. The image processing device as defined in claim 1,
the imaging section including a movable lens that can be set at a plurality of lens positions that differ in in-focus object plane position, and the in-focus object plane position being controlled by driving the movable lens using a lens driver section, and
the electronic zoom condition setting section setting the electronic zoom condition based on the distance information when the in-focus object plane position is closer to the imaging section than a given threshold value.

16. The image processing device as defined in claim 15,
the lens driver section controlling the in-focus object plane position stepwise by selecting a lens position from a given number of lens positions.

17. The image processing device as defined in claim 16,
the lens driver section moving the movable lens to a first lens position or a second lens position, the first lens position being a lens position at which the in-focus object plane position is a near point, and the second lens position being a lens position at which the in-focus object plane position is a far point that is a point farther from the imaging section than the near point, and
the electronic zoom condition setting section setting the electronic zoom condition based on the distance information when the in-focus object plane position is the near point.

18. The image processing device as defined in claim 1,
the electronic zoom condition setting section setting the electronic zoom magnification to a first given magnification when the distance indicated by the distance information is shorter than a first distance.

19. The image processing device as defined in claim 18,
the first distance being determined based on the distance at an endpoint of a depth-of-field range of the imaging section that is closer to the imaging section.

20. The image processing device as defined in claim 1,
the electronic zoom condition setting section setting the electronic zoom magnification to a second given magnification when the distance indicated by the distance information is longer than a second distance.

21. The image processing device as defined in claim 20,
the second distance being determined based on the distance at an endpoint of a depth-of-field range of the imaging section that is farther from the imaging section.

22. The image processing device as defined in claim 1,
the electronic zoom condition setting section setting a zoom center position used for the electronic zoom process as the electronic zoom condition, and
the electronic zoom condition setting section setting the zoom center position based on at least one of the image and the distance information.

23. The image processing device as defined in claim 22, further comprising:
an attention area detection section that detects an attention area from the image,
the electronic zoom condition setting section setting the zoom center position based on the attention area detected by the attention area detection section.

24. The image processing device as defined in claim 1, further comprising:
a highlight processing section that performs a highlight process on the image subjected to the electronic zoom process,
the highlight processing section performing the highlight process based on the electronic zoom magnification set by the electronic zoom condition setting section.

25. The image processing device as defined in claim 1,
the image acquisition section acquiring a stereo image as the image, and
the distance acquisition section acquiring the distance information by performing a stereo matching process on the stereo image.

26. The image processing device as defined in claim 1,
the distance acquisition section acquiring the distance information based on a ranging signal output from a ranging sensor included in the imaging section.

27. An image processing method comprising:
acquiring an image in time series, the image having been captured by an imaging section, and including an object;
acquiring distance information based on a distance from the imaging section to the object;
increasing an electronic zoom magnification as the distance indicated by the distance information decreases with respect to a given depth of field of the imaging section; and
performing an electronic zoom process on the image using the electronic zoom magnification.

28. An information storage device with an executable program stored thereon, wherein the program instructs a computer to perform steps of:
acquiring an image in time series, the image having been captured by an imaging section, and including an object;
acquiring distance information based on a distance from the imaging section to the object;
increasing an electronic zoom magnification as the distance indicated by the distance information decreases with respect to a given depth of field of the imaging section; and
performing an electronic zoom process on the image using the electronic zoom magnification.
